(19) United States
(12) Patent Application Publication
(10) Pub. No.: US 2026/0037737 A1
(43) Pub. Date: Feb. 5, 2026

(54) System and Method for Managing Information Compliance and Relevance Using Autonomous Artificial Intelligence (AI) Agents in Data Transfer and Communication Environments

(71) Applicant: Allen O'Neill, Valencia (ES)

(72) Inventor: Allen O'Neill, Valencia (ES)

(21) Appl. No.: 19/290,656

(22) Filed: Aug. 5, 2025

Related U.S. Application Data
(60) Provisional application No. 63/679,404, filed on Aug. 5, 2024.

(51) Int. Cl. G06F 40/30; G06F 11/34

(52) U.S. Cl. CPC G06F 40/30; G06F 11/3466

(57) ABSTRACT

System and method for managing information compliance and relevance using autonomous artificial intelligence (AI) agents in data transfer and communication environments. Some embodiments may include a core orchestration engine with multiple autonomous AI agents configured to manage and evaluate the compliance and relevance of information in communication and data transfer environments. The system may use weighted metrics to assess if information and actions comply with regulations and are pertinent to recipients, monitor email and data transfer, ensure regulatory compliance, and enhance information and knowledge sharing within organizations. The system may use semantic embeddings, part-of-speech analysis, and language models to extract and apply regulatory rules efficiently. These features may significantly reduce search space, computational overhead, and manual effort while improving security and accuracy.

### RELATED APPLICATIONS

This application claims the benefit of priority to U.S. Provisional Patent Application No. 63/679,404 entitled “System and Method for Managing Information Compliance and Relevance Using Autonomous Artificial Intelligence (AI) Agents in Data Transfer and Communication Environments” filed on Aug. 5, 2024, the entire contents of which are hereby incorporated by reference for all purposes.

### BACKGROUND

Unauthorized dissemination of data may result in significant legal and financial repercussions. With the advent of advanced data transfer systems and communication platforms, the volume and velocity of information exchange have increased dramatically. Consequently, conventional solutions for monitoring information and regulatory compliance may no longer be adequate. Therefore, there is a need for robust systems capable of evaluating and managing information flow to prevent breaches.

### SUMMARY

Various aspects include methods of using artificial intelligence (AI) agents to manage and evaluate the compliance and relevance of information and actions within a communication and data transfer environment, the method which may include receiving input data from one or more sources, preprocessing the input data to extract relevant attributes, classifying the input data based on the extracted attributes, aligning the input data with stored weights, performing semantic and linguistic analysis on regulatory documents to extract key phrases, rules, and requirements, generating rules from the extracted key phrases, rules, and requirements, orchestrating interactions between autonomous AI agents within a core orchestration engine, in which the autonomous AI agents perform specific evaluations, evaluating the input data based on the assessments of the autonomous AI agents to determine compliance and relevance, and sending the evaluated input data to intended recipients in response to determining that the data may be compliant and relevant.

Some aspects may further include generating feedback based on the evaluation and distribution of the data, updating stored values and weights based on the generated feedback, storing processed data, analysis results, and distribution records in a storage system, and periodically updating the storage system based on new data and feedback. In some aspects, storing the processed data, analysis results, and distribution records further may include maintaining indexes, original data inputs, and connections between indexed data and the original inputs, and organizing stored data into regulation storage, user content storage, and user access storage. In some aspects, classifying the input data based on the extracted attributes and aligning the input data with the stored weights further may include using semantic embeddings and language models to extract key phrases and rules from the input texts.

In some aspects, performing the semantic and linguistic analysis on the regulatory documents to extract the key phrases, rules, and requirements further may include performing part of speech analysis on regulatory documents to identify model/auxiliary verbs and distinguish between mandatory and optional actions. In some aspects, performing the semantic and linguistic analysis on the regulatory documents to extract the key phrases, rules, and requirements further may include performing part of speech analysis on regulatory documents to identify model/auxiliary verbs and other linguistic features, extracting key phrases, rules, and requirements using advanced language models, and generating rules from the extracted key phrases, rules, and requirements.

In some aspects, orchestrating interactions between the autonomous AI agents further may include dynamically adjusting the weights assigned to one or more of the attributes based on real-time data and feedback. In some aspects, orchestrating interactions between autonomous AI agents further may include facilitating communication and collaboration between the compliance agent, relevance agent, security agent, and analysis agent. In some aspects, orchestrating interactions between autonomous AI agents further may include managing interactions between the compliance agent, relevance agent, security agent, and analysis agent using the core orchestration engine, and evaluating the input data based on the assessments of the compliance agent, relevance agent, security agent, and analysis agent.

In some aspects, sending the evaluated input data to the intended recipients in response to determining that the data may be compliant and relevant further may include implementing weighted metrics to prioritize the relevance and urgency of the information. In some aspects, sending the evaluated input data to the intended recipients in response to determining that the data may be compliant and relevant further may include sending the compliant and relevant data to the intended recipients, collecting feedback from the recipients regarding the relevance and compliance of the data, and updating stored values and weights based on the collected feedback.

Some aspects may further include updating stored values and weights by monitoring system performance and feedback, updating the semantic store, regulation weights, content weights, and access control weights, and adjusting agent interactions and evaluation criteria based on updated data. Some aspects may further include generating a report based on the evaluated input data by triggering a report generation event based on predefined schedules or feedback, gathering and classifying necessary information for the report, generating the report structure based on stored requirements and feedback, determining whether the gathered information may be sufficient, generating and distributing the report in response to determining the gathered information may be sufficient, and generating feedback and updating values and weights in response to determining the gathered information may be insufficient. In some aspects, evaluating the data relevance may include using calculated weights related to content to determine the relevance of the data to the intended recipients, and applying the weights dynamically based on real-time analysis and feedback. In some aspects, evaluating the data relevance may include using calculated weights related to content to determine the relevance of the data to the intended recipients, and using calculated weights related to actions to evaluate the relevance and regulatory compliance of proposed actions.

Some aspects may further include detecting a preferred communication language or information format associated with an intended recipient, determining whether stored communication content corresponds to the detected preferred communication language or information format, and in response to determining that the stored communication content does not correspond to the detected preferred communication language or information format, translating, by an autonomous translation agent executed by the processing system, the stored communication content into the detected preferred communication language or converting the content into the detected information format, generating semantic embeddings or numeric representation tokens representing the translated or converted communication content, calculating embedding distances between previously stored embeddings of the communication content and embeddings of current communication content versions, and persisting translated or converted communication content for subsequent reuse in response to determining that calculated embedding distances do not exceed a predefined threshold.

Further aspects may include a computing device with at least one processor or processing system configured with processor-executable instructions to perform various operations corresponding to the described methods. Further aspects may include a computing device having various means for performing functions corresponding to these method operations. Further aspects may include a non-transitory processor-readable storage medium having stored processor-executable instructions configured to cause at least one processor or processing system to perform the operations of the described methods.

### BRIEF DESCRIPTION OF THE DRAWINGS

The accompanying drawings, which are incorporated herein and constitute part of this specification, illustrate exemplary aspects of the invention and, together with the general description given above and the detailed description given below, serve to explain the features of the invention.

FIG. 1 is a component block diagram illustrating an example storage system that includes components suitable for managing information compliance and relevance using autonomous AI agents in data transfer and communication environments in accordance with some embodiments.

FIG. 2 is a component block diagram illustrating an orchestration system suitable for implementing some embodiments.

FIG. 3 is a component block diagram illustrating an information gathering agent suitable for implementing some embodiments.

FIG. 4 is a component block diagram illustrating a user privilege and access discovery system suitable for implementing some embodiments.

FIG. 5 is a component block diagram illustrating a content distribution evaluation system suitable for implementing some embodiments.

FIG. 6 is a component block diagram illustrating a regulatory information analysis system suitable for implementing some embodiments.

FIG. 7 is a component block diagram illustrating a regulatory content processor suitable for implementing some embodiments.

FIG. 8 is a component block diagram illustrating a user content discovery system suitable for implementing some embodiments.

FIG. 9 is a component block diagram illustrating a content processor suitable for implementing some embodiments.

FIG. 10 is a component block diagram illustrating an access control agent suitable for implementing some embodiments.

FIG. 11 is a component block diagram illustrating a regulation control agent suitable for implementing some embodiments.

FIG. 12 is a component block diagram illustrating an orchestration agent suitable for implementing some embodiments.

FIG. 13 is a component block diagram illustrating a distribution agent suitable for implementing some embodiments.

FIG. 14 is a component block diagram illustrating an information/instruction analysis agent suitable for implementing some embodiments.

FIG. 15 is a component block diagram illustrating a storage update trigger system suitable for implementing some embodiments.

FIG. 16 is a component block diagram illustrating a report generation agent suitable for implementing some embodiments.

FIG. 17 is a network component block diagram illustrating a relevance control agent suitable for implementing some embodiments.

FIG. 18 is a network component block diagram illustrating a relevance analysis system suitable for implementing some embodiments.

FIG. 19 is a network component block diagram illustrating a feedback process suitable for implementing some embodiments.

FIG. 20 is a network component block diagram illustrating an example workflow knowledge sharing distribution in accordance with some embodiments.

FIG. 21 is a network component block diagram illustrating an example workflow for action control in accordance with some embodiments.

FIG. 22 is a network component block diagram illustrating an example workflow for electronic data transfer in accordance with some embodiments.

FIG. 23 is a network component block diagram illustrating an example workflow for electronic email or message transfer in accordance with some embodiments.

FIG. 24 is a process flow diagram illustrating a method of using artificial intelligence (AI) agents to manage and evaluate the compliance and relevance of information and actions within a communication and data transfer environment in accordance with some embodiments.

FIG. 25 is a component diagram of system on chip (SOC) suitable for implementing some embodiments.

FIG. 26 is a component diagram of server suitable for implementing some embodiments.

### DETAILED DESCRIPTION

The various embodiments may be described in detail with reference to the accompanying drawings. Wherever possible, the same reference numbers may be used throughout the drawings to refer to the same or like parts. References made to particular examples and implementations are for illustrative purposes and are not intended to limit the scope of the invention or the claims.

The word “exemplary” may be used herein to mean “serving as an example, instance, or illustration”. Any implementation described herein as “exemplary” is not necessarily to be construed as preferred or advantageous over other implementations.

The term “computing device” may be used herein to refer to any or all of server computing devices, personal computing devices, desktop computers, workstations, laptops, netbooks, Ultrabooks, tablets, smartphones, personal data assistants (PDAs), palm-top computers, wearable devices (e.g., smartwatches, fitness trackers, AR glasses, head-mounted displays, earbuds, smart clothing, etc.), multimedia-enabled mobile devices, Internet of Things (IoT) devices (e.g., smart TVs, speakers, locks, lighting systems, switches, doorbell cameras, and security systems, etc.), connected vehicles, audio devices (e.g., HomePod™, Echo™, etc.), gaming systems (e.g., PlayStation™, Xbox™, Nintendo Switch™, etc.), media players (e.g., Roku™, Apple TV™, etc.) digital video recorders (DVRs), robotic device, human electronic interface, or bio-electronic interface, or other such hybrid interface, and other similar devices that include a memory and programmable processor for providing the functionality described herein.

The term “processing system” may be used herein to refer to one or more processors, including multi-core processors, that are organized and configured to perform various computing functions. Various embodiment methods may be implemented in one or more of multiple processors within a processing system as described herein.

The term “web browser” may be used herein to refer to a software and/or hardware client on a computing device that is configured to retrieve web resources from a web server. As an example, a web browser may be a mobile or desktop or virtual software application operating on a processor of a computing device that utilizes a display for user interaction. As further examples, a web browser may be a component embedded within a mobile or desktop application on the computing device, or a software module running on a server without any display capabilities in a data center (often referred to as an “automated web browser,” a “headless browser” or a “headless server”). A web browser may be an audio device that retrieves web resources from a web server and subsequently presents the information included in the web resources to a user in an audio format (e.g., by reading parts of the web resources, etc.). The audio device may be capable of receiving voice instructions from a user, and subsequently converting these into a format that can be sent to the web server. Examples of such web browsers/clients include Apple's Siri on HomePod, Amazon's Alexa on Echo, and Google Assist on Nest. In some embodiments, a web browser may be part of a vehicle, and it may interact with the driver using the vehicle's existing hardware (e.g., information may be presented to the driver using a heads-up display, the driver may provide instructions using buttons on the steering wheel, etc.). The web browser may be a headset device (e.g., smart glasses) that is used to present the user with an augmented reality (AR) environment and/or a virtual reality (VR) environment. Such headset devices are becoming increasingly popular in the context of eCommerce (e.g., AR may be used to digitally place a piece of furniture into a real scene so that the potential purchaser can see how it will look, VR may be used to allow a user to inspect a life-size model of a new car, etc.). In some embodiments, a web browser may be a software application that emulates any of the web browser types described herein. In some embodiments, the web browser may include a website analysis system.

The terms “machine learning algorithm,” “artificial intelligence model” and the like may be used herein to refer to any of a variety of information structures that may be used by a computing device to perform a computation or evaluate a specific condition, feature, factor, dataset, or behavior on a device. Examples of machine learning (ML) algorithms include network models, neural network models, inference models, neuron models, classifiers, random forest models, spiking neural network (SNN) models, convolutional neural network (CNN) models, recurrent neural network (RNN) models, deep neural network (DNN) models, generative network models, ensemble networks, generative adversarial networks, reinforcement learning models, and genetic algorithm models. In some embodiments, a machine learning algorithm may include an architectural definition (e.g., the neural network architecture, etc.) and one or more weights (e.g., neural network weights, etc.).

The term “neural network” may be used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” may be used herein to refer to a process that is performed at runtime or during execution of the software application program corresponding to the machine learning algorithm. Inference may include traversing the processing nodes in a network (e.g., neural network, etc.) along a forward path (which may include some backwards traversals) to produce one or more values as an overall activation or overall “inference result”.

The term “deep neural network” may be used herein to refer to a neural network that implements a layered architecture in which the output/activation of a first layer of nodes becomes an input to a second layer of nodes, the output/activation of a second layer of nodes becomes an input to a third layer of nodes, and so on. As such, computations in a deep neural network may be distributed over a population of processing nodes that make up a computational chain. Deep neural networks may also include activation functions and sub-functions between the layers. The first layer of nodes of a multilayered or deep neural network may be referred to as an input layer. The final layer of nodes may be referred to as an output layer. The layers in-between the input and final layer may be referred to as intermediate layers.

The term “convolutional neural network” (CNN) may be used herein to refer to a deep neural network in which the computation in at least one layer is structured as a convolution. A convolutional neural network may also include multiple convolution-based layers, which allows the neural network to employ a very deep hierarchy of layers. In convolutional neural networks, the weighted sum for each output activation is computed based on a local receptive field, and the same matrices of weights (called “filters”) are applied to every output. These networks may also implement a fixed feedforward structure in which all the processing nodes that make up a computational chain are used to process every task, regardless of the inputs. In such feed-forward neural networks, all of the computations are performed as a sequence of operations on the outputs of a previous layer. The final set of operations may generate the overall inference result of the neural network, such as a probability that an image contains a specific object (e.g., a person, cat, watch, edge, etc.) or information indicating that a proposed action should be taken.

The term “recurrent neural network” (RNN) may be used herein to refer to a class of neural networks particularly well-suited for sequence data processing. Unlike feedforward neural networks, RNNs may include cycles or loops within the network that allow information to persist. This enables RNNs to maintain a “memory” of previous inputs in the sequence, which may be beneficial for tasks in which temporal dynamics and the context in which data appears are relevant.

The term “long short-term memory network” (LSTM) may be used herein to refer to a specific type of RNN that addresses some of the limitations of basic RNNs, particularly the vanishing gradient problem. LSTMs include a more complex recurrent unit that allows for the easier flow of gradients during backpropagation. This facilitates the model's ability to learn from long sequences and remember over extended periods, making it apt for tasks such as language modeling, machine translation, and other sequence-to-sequence tasks.

The term “transformer” may be used herein to refer to a specific type of neural network that includes an encoder and/or a decoder and is particularly well-suited for sequence data processing. Transformers may use multiple self-attention components to process input data in parallel rather than sequentially. The self-attention components may be configured to weigh different parts of an input sequence when producing an output sequence. Unlike solutions that focus on the relationship between elements in two different sequences, self-attention components may operate on a single input sequence. The self-attention components may compute a weighted sum of all positions in the input sequence for each position, which may allow the model to consider other parts of the sequence when encoding each element. This may offer advantages in tasks that benefit from understanding the contextual relationships between elements in a sequence, such as sentence completion, translation, and summarization. The weights may be learned during the training phase, allowing the model to focus on the most contextually relevant parts of the input for the task at hand. Transformers, with their specialized architecture for handling sequence data and their capacity for parallel computation, often serve as foundational elements in constructing large generative AI models (LXM).

The term “large generative AI model” (LXM) may be used herein to refer to an advanced computational framework that includes any of a variety of specialized AI models including, but not limited to, large language models (LLMs), large speech models (LSMs), large/language vision models (LVMs), vision language models (VLMs)), hybrid models, multi-modal models, and large positioning models (LPMs). LPMs may be particularly useful for media technologies that operate in multidimensional spaces such as extended reality (XR), which includes virtual reality (VR), augmented reality (AR), and mixed reality (MR). LPMs may extend beyond traditional two-dimensional frameworks by incorporating additional axes for analysis, including spatial positioning and interaction within virtual environments.

An LXM may include multiple layers of neural networks (e.g., RNN, LSTM, transformer, etc.) with millions or billions of parameters. Unlike traditional systems that translate user prompts into a series of correlated files or web pages for navigation, LXMs support dialogic interactions and encapsulate expansive knowledge in an internal structure. As a result, rather than merely serving a list of relevant websites, LXMs are capable of providing direct answers and/or are otherwise adept at various tasks, such as text summarization, translation, complex question-answering, conversational agents, etc. In various embodiments, LXMs may operate independently as standalone units, may be integrated into more comprehensive systems and/or into other computational units (e.g., those found in a SoC or SIP, etc.), and/or may interface with specialized hardware accelerators to improve performance metrics such as latency and throughput. In some embodiments, the LXM component may be enhanced with or configured to perform an adaptive algorithm that allows the LXM to better understand context information, spatial positioning and interaction within virtual environments, evaluating weights of connections between nodes in a feature graph, etc. In some embodiments, the adaptive algorithms may be performed by the same processing system that manages the core functionality of the LXM and/or may be distributed across multiple independent processing systems.

The terms “contextualized query” and “contextualized query response” may be used herein to refer to a query or query response that has been augmented with additional contextual data or metadata to improve the relevance and specificity of information contained therein. For example, some embodiments may include components configured to generate and send a contextualized query to an external system (e.g., knowledge database, LXM, etc.) to receive a contextualized query response.

The term “relevance model” may be used herein to refer to a computational unit or LXM trained to evaluate the importance or pertinence of various elements within a given set of data.

The term “feature space” may be used herein to refer to a multi-dimensional space or information structure in which each dimension represents a specific feature or attribute of the data being analyzed. Each data point (e.g., object, event, observation, etc.) may be represented as a vector in this multi-dimensional space/structure. The dimensions of the feature space may correspond to the features of the dataset, which may include various properties or characteristics of the data points. For example, in a dataset of images, features might include color histograms, texture, shape descriptors, etc.

The term “feature graph” may be used herein to refer to a sophisticated information structure that represents the relationships and interactions between different data points and their features as nodes and edges in a graph. The nodes typically represent data points or features, and edges represent the relationships or dependencies between them. A feature graph may represent the relationships and interactions between different data points and features and be particularly useful in complex data sets in which the relationships between features are as important as the features themselves. Some embodiments may include components configured to use neural networks to analyze and interpret the relationships and attributes of data within a multidimensional feature space, and then use a feature graph to represent and understand the complex interactions between these data points.

The term “embedding layer” may be used herein to refer to a specialized layer within a neural network, typically at the input stage, that transforms continuous or discrete categorical values or tokens into feature spaces or continuous, high-dimensional vectors. An embedding layer may also transform high-dimensional data into low-dimensional vectors (e.g., using “dimensionality reduction” techniques, etc.), which may be particularly useful when the original data is complex or too large to handle efficiently. In some embodiments, the embedding layer may convert tokens (typically low-dimensional entities) into high-dimensional vectors, feature spaces, and/or feature graphs. An embedding layer may operate as a lookup table in which each unique token or category is mapped to a point in a continuous vector space. The vectors may be refined during the model's training phase to encapsulate the characteristics or attributes of the tokens in a manner that is conducive to the tasks the model is configured to perform.

The term “token” may be used herein to refer to a unit of information that an LXM may read as a single input during training and inference. Each token may represent any of a variety of different data types. For example, in text-centric models such as in LLMs, each token may represent a one or more textual element such as a paragraph(s), sentence(s), clause(s), word(s), sub-word(s), character(s), etc. In models designed for auditory data, such as LSMs, each token may represent a feature extracted from audio signals, such as a phoneme, spectrogram, temporal dependency, Mel-frequency cepstral coefficients (MFCCs) that represent small segments of an audio waveform, etc. In visual models such as LVM, each token may correspond to a portion of an image (e.g., pixel blocks), sequences of video frames, etc. In hybrid systems that combine multiple modalities (text, speech, vision, etc.), each token may be a complex data structure that encapsulates information from various sources. For example, a token may include both textual and visual information, each of which independently contributes to the token's overall representation in the model.

Each token may be converted into a numerical vector via the embedding layer. Each vector component (e.g., numerical value, parameter, etc.) may encode an attribute, quality, or characteristic of the original token. The vector components may be adjustable parameters that are iteratively refined during the model training phase to improve the model's performance during subsequent operational phases. The numerical vectors may be high-dimensional space vectors (e.g., containing more than a thousand dimensions, etc.) in which each dimension in the vector captures a unique attribute, quality, or characteristic of the token. For example, dimension 1 of the numerical vector may encode the frequency of a word's occurrence in a corpus of data, dimension 2 may represent the pitch or intensity of the sound of the word at its utterance, dimension 3 may represent the sentiment value of the word, etc. Such intricate representation in high-dimensional space may help the LXM understand the semantic and syntactic subtleties of its inputs. During the operational phase, the tokens may be processed sequentially through layers of the LXM or neural network, which may include structures or networks appropriate for sequence data processing, such as transformer architectures, recurrent neural networks (RNNs), or long short-term memory networks (LSTMs).

The term “sequence data processing” may be used herein to refer to techniques or technologies for handling ordered sets of tokens in a manner that preserves their original sequential relationships and captures dependencies between various elements within the sequence. The resulting output may be a probabilistic distribution or a set of probability values, each corresponding to a “possible succeeding token” in the existing sequence. For example, in text completion tasks, the LXM may suggest the possible succeeding token determined to have the highest probability of completing the text sequence. For text generation tasks, the LXM may choose the token with the highest determined probability value to augment the existing sequence, which may subsequently be fed back into the model for further text production.

The term “weak supervision” may be used herein to refer to a machine learning technique that uses noisy, limited, or imprecise sources of training data (as opposed to strong supervision techniques that require large sets of accurately labelled data). Systems that use weak supervision may learn from (and generate AI/ML models using) datasets that are less detailed, partially labelled, or otherwise not comprehensive or fully annotated. Some embodiments may include components (e.g., media analytics platform, etc.) configured to perform weak supervision operations, which may include constructing a training dataset based on weak, incomplete, or imprecise data and data sources (e.g., heuristic rules, approximate labels, data from related tasks, etc.). The components may perform weak supervision operations to, for example, learn from a wide array of preloaded images and brand associations that are not exhaustively labelled but may be used to extract valuable information for training the AI models.

The term “extended reality (XR)” may be used herein to refer to any of a variety of sense-enhancing technologies, including virtual reality (VR), augmented reality (AR), mixed reality (MR), and other technologies for processing, manipulating or presenting digital output (e.g., images, text, sounds, haptic feedback, tactile output, etc.) in two or three dimensions. For example, an XR application may be a virtual reality application that simulates a user's physical presence in a virtual environment, incorporating the temporal dimension and spatial positioning within that environment. An XR application may also be an augmented reality application that combines real-world images from a user's physical environment with computer-generated imagery, presenting images and information about people and/or objects to the user superimposed on the visual world as an augmented scene (and adding a spatial dimension). As yet another example, an XR software application may be a mixed reality application that merges real and virtual worlds to produce new environments and visualizations in which physical and digital objects co-exist and interact in real time (and including both temporal and spatial dimensions).

For case of reference, to improve readability, and to focus the discussion on the most relevant features, some of the embodiments below are discussed with reference to “video” or “media,” which encompasses XR and traditional two-dimensional media. However, it should be understood that the embodiments are applicable to a wide variety of media technologies, including those that operate in multidimensional spaces such as VR, AR, and MR. These technologies extend beyond traditional two-dimensional frameworks by introducing additional axes for analysis, such as spatial positioning and interaction in virtual environments. Accordingly, nothing in this application should be used to limit the claims to videos unless expressly recited as such in the body of the claims.

The term “artificial intelligence (AI) agent” may be used herein to refer to a software component or entity configured to perform tasks autonomously or semi-autonomously, often simulating human-like decision-making and problem-solving abilities. AI agents may include but are not limited to, machine learning models, neural networks, expert systems, and rule-based systems. These agents may process input data, make decisions based on predefined rules or learned patterns, interact with other AI agents, and adapt their behaviour based on new data and feedback. AI agents may be used in various applications such as data analysis, regulatory compliance, content relevance evaluation, and automated decision-making within communication and data transfer environments. In some embodiments, the AI agents may be configured to operate across different platforms and devices.

The various embodiments include computing devices equipped with components configured to use autonomous artificial intelligence (AI) agents, advanced linguistic analysis, and dynamic weight adjustments to manage and evaluate the compliance and relevance of information and actions within a communication and data transfer environment. The computing devices may include one or more processors, memory, and storage systems, as well as communication interfaces for receiving and transmitting data. The system architecture may be configured to facilitate the efficient processing and analysis of large volumes of data from multiple sources.

Some embodiments may include an input system configured to acquire data from various sources, such as email systems, messaging systems, file storage, data storage, retrieval systems, virtual reality systems, mobile systems, robotics systems, network systems, and multimedia systems. The input data may include text, audio, video, and other multimedia content.

Some embodiments may include a pre-processor component configured to perform an initial evaluation to determine the best approach for processing the data. This may include splitting the data into manageable parts and converting it into a suitable format for further processing. The pre-processing system may also include filtering and normalization operations.

Some embodiments may include a content processor and/or an extract processor configured to identify and categorize various aspects of the data. Example functions of the extract processor include identifying parts of speech, classifying content, identifying topics, determining stance, determining opinion, determining expertise or authority, detecting sentiment, recognizing entities and their relevant aspects, mapping connections between entities and topics, identifying jurisdictions and territories, analyzing dependencies and references, determining time boundaries, identifying data sources, and detecting additional relevant data or signals.

Some embodiments may include a weight processor configured to determine the importance and relevance of the identified elements. Example functions of the weight processor include calculating extract connections, determining authority weights, using content connections, generating a weight matrix, and summarizing weights for efficient analysis.

Some embodiments may include a semantic and linguistic analysis system configured to analyze regulatory documents to extract key phrases, rules, and requirements. In some embodiments, the semantic and linguistic analysis system may perform part-of-speech analysis to identify different parts of speech, including modal auxiliary verbs, and distinguish between mandatory and optional actions. In some embodiments, the semantic and linguistic analysis system may use advanced language models (LXMs, etc.) to extract key phrases, rules, and requirements. In some embodiments, the semantic and linguistic analysis system may generate rules based on the extracted key phrases, rules, and/or requirements.

Some embodiments may include a core orchestration engine that is configured to manage interactions between autonomous AI agents, including compliance agents, relevance agents, security agents, reporting agents, information agents, and analysis agents. The core orchestration engine may dynamically adjust weights assigned to various attributes based on real-time data and feedback and/or otherwise facilitate efficient communication and collaboration among the agents.

Some embodiments may include autonomous AI agents that evaluate the input data based on their assessments to determine compliance and relevance. For example, autonomous AI agents may use calculated weights related to content and actions to evaluate relevance and regulatory compliance, apply weights dynamically based on real-time analysis and feedback, and perform other similar operations.

Some embodiments may include a data distribution system that sends the evaluated data to the intended recipients in response to determining that the data is compliant and relevant. The system may implement weighted metrics to prioritize the relevance and urgency of the information. Feedback may be collected from the recipients regarding the relevance and compliance and accuracy of the data, and stored values and weights may be updated based on the collected feedback. The processed data, analysis results, and distribution records may be stored in a comprehensive storage system. In some embodiments, the system may maintain indexes, original data inputs, and connections between indexed data and the original inputs. In some embodiments, the data may be organized into regulation storage, user content storage, and user access storage.

Some embodiments may include a feedback component configured to continuously monitor performance and feedback to update the semantic store, regulation weights, content weights, and access control weights. Agent interactions and evaluation criteria may be adjusted based on updated data.

Some embodiments may include a report generator component configured to generate reports based on the evaluated input data, which may include triggering a report generation agent or event based on predefined schedules or feedback, gathering and classifying necessary information for the report, generating the report structure based on stored requirements and feedback, determining the sufficiency of gathered information, generating and distributing the report in response to determining the information is sufficient, and providing feedback and updating values and weights if the information is insufficient.

Some embodiments may include various AI or machine learning (ML) subsystems configured to implement AI/ML techniques to fine-tune or refine evaluation criteria and update stored values and weights.

Some embodiments may include a core orchestration engine with multiple agents that use weighted metrics to evaluate different attributes of communication and information. These agents may determine whether the information being exchanged complies with regulations and rules, whether proposed actions adhere to regulations, and whether the information is relevant to the recipient.

An example use case may include monitoring email and general data transfer. The system may examine information to be sent or received in emails or other messages, determining if the information should be sent by the sender, viewed by the recipient, and if it is relevant. For example, an email monitoring system may alert or take action if an email is about to be sent to the wrong recipient. This feature may be particularly valuable in environments in which releasing sensitive information to the wrong party could have significant consequences.

Another example use case may include information and knowledge sharing within organizations. As organizations grow, ensuring that the correct information reaches the right people becomes challenging. The system may monitor information relevant to the organization, collect feedback from stakeholders, determine appropriate distribution, and ensure that the information is accessible and relevant. For example, a knowledge-sharing system may regularly prompt users for updates and opinions and organize the information efficiently and in compliance with regulations for distribution.

In addition, the system may evaluate information and proposed actions by users or electronic agents to ensure regulatory compliance. This may include monitoring actions and related information, collecting feedback, and verifying compliance with regulatory requirements. For example, a system may guide users through prompt-driven instructions to collect and refine information needed for regulatory reporting. Another example is a system that monitors the actions of agents, such as users, robots, neural implants, virtual presences, or software, to ensure they meet regulatory standards.

Some embodiments may use autonomous AI agents and semantic embeddings to reduce the search space and ensure compliance during data dissemination. This approach may save computational time and costs while enhancing system security. Weightings inferred from network connections, user interactions, feedback, and external sources may help reduce computational and manual overhead.

Some embodiments may use part-of-speech analysis to examine regulatory documents. This analysis may focus on modal auxiliary verbs and related linguistic concepts to identify specific rule implementations. For example, in the phrase “You may go through the door,” the auxiliary verb “may” could indicate that the action is allowed but optional. Conversely, “You shall swipe your access card” may indicate that swiping the card is mandatory.

Some embodiments may use language models to extract key phrases, rules, and requirements from input texts. This extraction process, combined with part-of-speech analysis, may allow for the creation of a clear set of computer-readable rules that save computational time, reduce complexity, and improve information accuracy and security.

Some embodiments may use calculated weights related to information content to determine whether the content is relevant to a recipient and whether it may be distributed for access control or regulatory reasons. Similarly, some embodiments may use calculated weights related to proposed actions to determine whether an action is relevant to a recipient and if it can be carried out considering access control or regulatory compliance.

Thus, several practical use cases enhance the system's applicability. One notable use case involves email and data transfer monitoring. This feature allows the system to scrutinize information in emails or communication channels to ensure compliance and relevance. For example, it may prevent sensitive information from being sent to unintended recipients by alerting or taking action when an email is about to be misdirected. This capability may be particularly valuable where the risk and impact of unauthorized data dissemination are significant.

Another practical use case relates to information and knowledge sharing within organizations. As organizations expand, distributing the correct information to appropriate individuals becomes increasingly complex. Some embodiments may address this issue by monitoring information relevant to the organization, gathering feedback, and determining appropriate distribution channels. The system may ensure that disseminated information is both compliant and relevant by, for example, regularly prompting users for updates and opinions.

In addition, some embodiments include mechanisms that ensure information and proposed actions comply with regulatory requirements. This may include monitoring actions and related information, gathering feedback, and verifying compliance with applicable regulations, requirements, or contractual obligations. Examples include systems designed to collect and refine information for regulatory reporting, monitor the actions of various agents (such as users, robots, or software processes), and ensure these actions meet specified standards.

Some embodiments may use autonomous AI agents and semantic embeddings to significantly reduce the search space and computational overhead associated with compliance assurance. By using part-of-speech analysis, the system may accurately interpret regulatory documents and identify specific rule implementations, even in languages lacking grammaticalized auxiliaries. In addition, language models may extract key phrases, rules, and requirements from input texts, and numeric vectorized representations may allow for efficient data filtering and compliance verification.

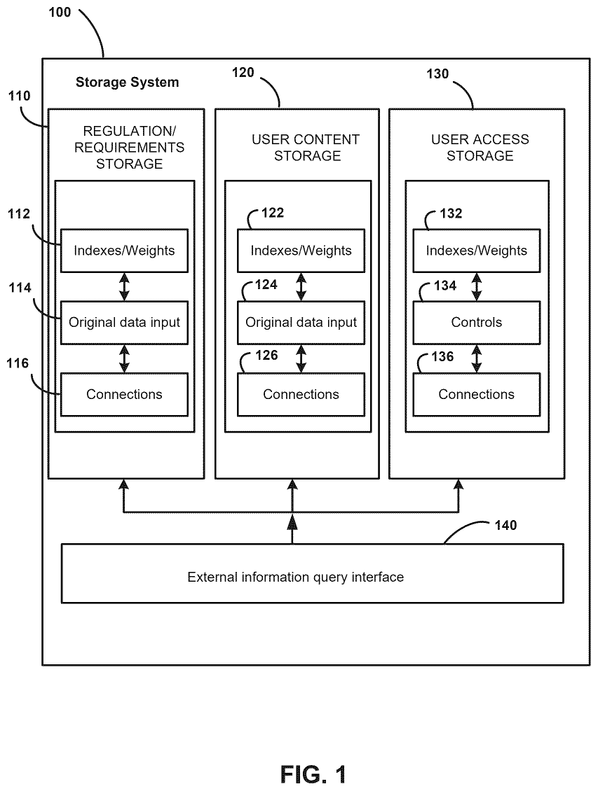

FIG. 1 illustrates an example computing system that could be configured to manage information compliance and relevance in data transfer and communication environments in accordance with some embodiments. In the example illustrated in FIG. 1, the computing system may include a storage system 100 that includes a regulation or requirements storage component 110, a user content storage component 120, and a user access storage component 130. The regulation or requirements storage component 110 may include indexes or weights 112, an original data input store 114, and a connections store 116. The user content storage component 120 may include indexes or weights 122, an original data input store 124, and a connections store 126. The user access storage component 130 may include indexes or weights 132, a controls store 134, and a connections store 136. The storage system 100 may communicate with an external information query interface 140.

The regulation or requirements storage component 110 may maintain regulatory indexes or weights 112, preserve original regulatory data inputs 114, and record connections 116 that connect each index or weight to the source text. For example, the regulation or requirements storage component 110 may parse statutory or contractual clauses and assign a numeric weight to each clause.

The user content storage component 120 may maintain indexes or weights 122 that summarize attributes of user generated content, preserve original data inputs 124 that include email bodies, files, or messages, and record connections 126 that connect each index or weight to the originating content. For example, the user content storage component 120 may embed each paragraph in a vector space and assign relevance weights that reflect topic similarity with current projects.

The user access storage component 130 may maintain indexes or weights 132 that quantify access privileges, store controls 134 that specify policy statements, and record connections 136 that connect each privilege to a specific identity or role. For example, the user access storage component 130 may maintain a matrix that maps user roles to permissible content categories and include time-bound restrictions.

The external information query interface 140 may expose a standardized endpoint that allows the storage system 100 to receive context from remote sources or to provide indexes weights and controls to external analytic services. For example the external information query interface 140 may accept a regulatory citation and return the corresponding weighted rule extracted from the regulation or requirements storage component 110.

Any or all of the arrows in FIG. 1 may represent logical data pathways, which may be used to synchronize indexes weights and connections across the three storage components 110, 120, 130 and deliver updates to and from the external information query interface 140. These pathways may, for example, allow the storage system 100 to maintain consistent alignment between regulatory obligations, user generated content, and user privileges.

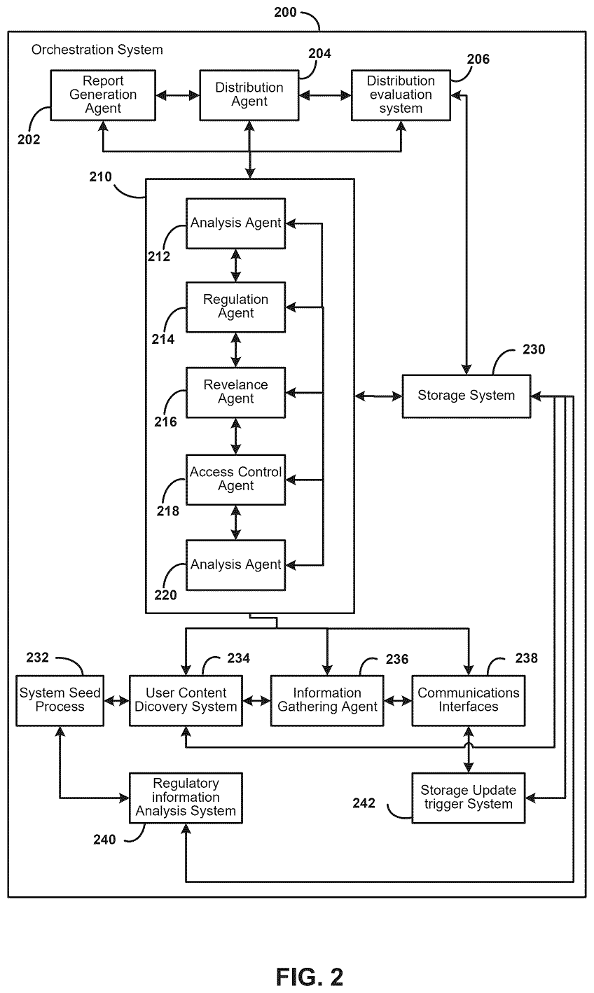

FIG. 2 illustrates an example orchestration system 200 that may manage agent interactions and data flow in accordance with some embodiments. In the example illustrated in FIG. 2, the orchestration system 200 includes a report generation agent 202, a distribution agent 204, a distribution evaluation system 206, and a core orchestration engine 210. The core orchestration engine 210 may include a first analysis agent 212, a regulation agent 214, a relevance agent 216, an access control agent 218, and a second analysis agent 220. The orchestration system 200 may communicate with a storage system 230, a system seed process 232, a user content discovery system 234, an information gathering agent 236, communications interfaces 238, a regulatory information analysis system 240, and a storage update trigger system 242.

The report generation agent 202 may be configured to assemble structured reports that summarize compliance outcomes relevance metrics and distribution records stored in the storage system 230. The distribution agent 204 may route evaluated content to intended recipients and send delivery metadata to the distribution evaluation system 206. The distribution evaluation system 206 may compare delivery results with predefined objectives and forward feedback to the core orchestration engine 210 and to the storage system 230.

The core orchestration engine 210 may coordinate the internal agents. For example, the first analysis agent 212 may inspect incoming data attributes and suggest routing directives, the regulation agent 214 may compare content attributes with weighted regulatory rules obtained from the regulatory information analysis system 240, the relevance agent 216 may compare content vectors with user interest profiles obtained from the user content discovery system 234, the access control agent 218 may compare proposed deliveries with privilege matrices stored in the storage system 230, and the second analysis agent 220 may aggregate the preceding evaluations and output a composite decision that guides the distribution agent 204.

The storage system 230 may preserve indexes and connections generated during the evaluations and expose these structures to the orchestration system 200. The system seed process 232 may populate initial regulatory data sets user profiles and privilege matrices before operational use. The user content discovery system 234 may scan enterprise repositories and attach relevance weights to discovered items. The information gathering agent 236 may query external sources and supply supplemental attributes that refine compliance or relevance assessments. Communications interfaces 238 may transfer data between the orchestration system 200 and external messaging platforms file stores or application programming interfaces.

The regulatory information analysis system 240 may parse statutes industry standards and contractual clauses and assign numeric weights that the regulation agent 214 uses during compliance checks. The storage update trigger system 242 may observe feedback trends and system performance metrics and initiate updates that refresh stored weights indexes and privilege matrices.

Some embodiments may include methods of for automated information gathering and evaluation performed by a processor or processing system in a computing device. In some embodiments, the methods may include detecting an event trigger by comparing a received data freshness alert against stored trigger rules, retrieving input data responsive to detecting the event trigger (in which retrieving may include sending a secure request to a remote repository endpoint and temporarily storing retrieved data in transient memory), determining a plurality of potential data source endpoints by querying an endpoint registry that maps content domains to Application Programming Interface (API) endpoints based on a topic label derived from the input data, selecting an optimal data source endpoint from the plurality of potential data source endpoints by performing a weighted similarity analysis between a vector-space representation of the input data and stored regulatory weights (in which the optimal data source endpoint corresponds to a highest similarity score that exceeds a predetermined threshold), transmitting serialized instructions specifying the optimal data source endpoint and data extraction parameters to one or more remote agents via message queues to initiate parallel data acquisition, evaluating a communication medium preference vector (which may include ranked communication channels and in which the evaluation may include selecting a preferred communication channel based on stored user preference weights adjusted for message sensitivity), constructing a communication message (which may include a summary referencing extracted data and a secure hyperlink directing to supporting documents based on the selected communication channel), receiving acquired result data from the one or more remote agents (in which the result data include a data integrity hash, etc.) validating completeness of the acquired result data based on the presence of mandatory metadata fields, and automatically updating relevance scores and stored regulatory weights in a persistent database responsive to determining that the acquired result data meets completeness criteria.

In some embodiments, detecting the event trigger may further include periodically polling a message queue for the data freshness alert at defined intervals. In some embodiments, retrieving input data may further include issuing a Hypertext Transfer Protocol Secure (HTTPS) GET request and receiving a JavaScript Object Notation (JSON) formatted payload. In some embodiments, performing the weighted similarity analysis may further include embedding textual content of the input data into a multidimensional vector space. In some embodiments, performing the weighted similarity analysis may further include calculating cosine similarity scores between the embedded textual content and regulatory weights stored in a regulatory information analysis system. In some embodiments, transmitting serialized instructions may further include serializing authentication credentials required by the optimal data source endpoint. In some embodiments, selecting the preferred communication channel may further include resolving the preferred communication channel prior to constructing the communication message to reduce computational overhead. In some embodiments, constructing the communication message may further include prompting an external language model to generate the summary based on the input data. In some embodiments, validating completeness of the acquired result data may further include automatically transmitting a request for additional data responsive to identifying an incomplete mandatory metadata field.

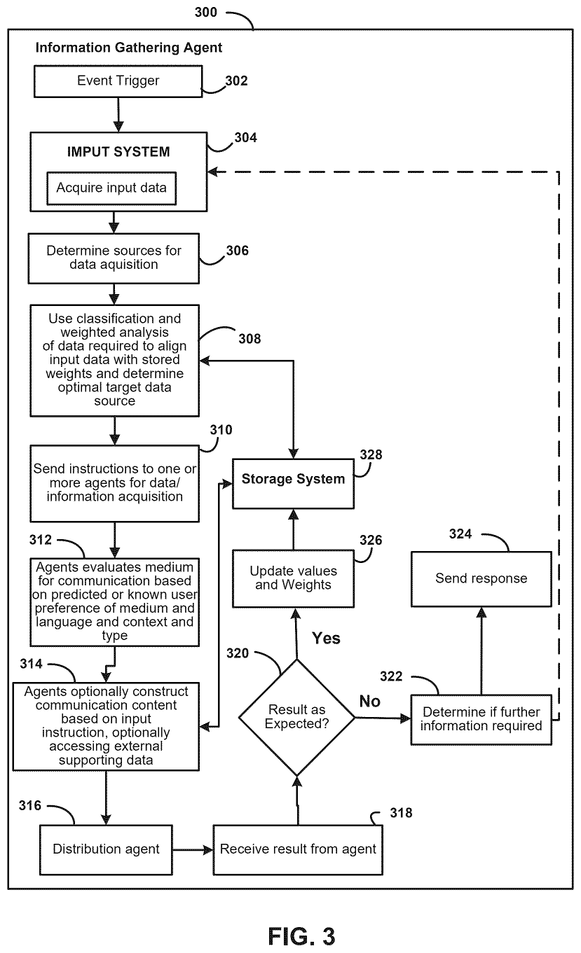

FIG. 3 illustrates operations performed by an information gathering agent 300 configured in accordance with some embodiments. The agent 300 may include an event trigger 302, an input system 304, and a storage system 328.

In block 302, the processing system (e.g., a processor associated with the information gathering agent, etc.) may detect an event trigger. For example, the processing system may poll a message queue for a data freshness alert, compare the alert to a trigger rule stored in memory, and identify matching events as triggers.

In block 304, the processing system (e.g., a processor associated with the input system, etc.) may acquire input data. For example, the processing system may issue a Hypertext Transfer Protocol Secure (HTTPS) GET request to a remote document repository, retrieve and copy JSON payload into transient memory, and store the raw content for subsequent analysis.

In block 306, the processing system (e.g., processor associated with the information gathering agent, etc.) may determine sources for data acquisition. For example, the processing system may query the endpoint registry that maps content domains to API endpoints and selects endpoints that match the topic label of the input data.

In block 308, the processing system may use classification and weighted analysis of data align input data with stored weights and determine optimal target data source. For example, the processing system may embed the input text in a vector space, retrieve regulation weights from the regulatory information analysis system 240, compute a similarity metric (e.g., cosine similarity, etc.), and select the source with the highest score above a threshold.

In block 310, the processing system may send instructions to one or more agents for data or information acquisition. For example, the processor serializes a message that specifies the target endpoint, authentication token, and extraction parameters, and sends the message to designated agent queues to enable parallel retrieval while maintaining orchestration control.

In block 312, the processing system may evaluate the medium for communication based on predicted or known user preference of medium, language, context, and type. For example, the processing system may access a user preference vector that ranks channels such as email, SMS, and dashboard notification, select the channel with the highest weight after adjusting for message sensitivity, and resolve the channel early to reduce rework by the distribution agent 204.

In block 314, a processor in the analysis agent may optionally construct communication content based on input instruction and access external supporting data. For example, the processing system may prompt a language model to generate a summary that cites extracted data and embeds a secure link to supporting documents.

In block 316, a processor in the information gathering agent may send the communication content to a distribution agent. For example, the processing system may enqueue the constructed message in a relay message and log the message identifier in the storage system for audit traceability.

In block 318, a processor in the information gathering agent may receive the results from the agent. For example, the processing system may read a completion message that includes a hash of the retrieved data and a success code and record the hash in memory to verify successful acquisition.

In block 320, the processing system may determine whether the results are as expected. In response to determining that the results are not as expected (i.e., determination block 320=“No”), the processing system may determine if further information is required in block 322. For example, the processing system may check whether mandatory metadata fields exist in the payload and mark the data incomplete when a field lacks a value. In block 324, the processing system may send a response message that includes the compiled content or a request for additional data.

In response to determining that the results are as expected (i.e., determination block 320=“Yes”), the processing system may update values and weights in block 326. For example, the processing system may increase a relevance score in a key-value store when the recipient signals satisfaction. In block 328, the storage system 328 may persist the updated weights and the new data snapshot in a columnar database.

Some embodiments may include methods of dynamically determining and indexing user privileges and access control information. In some embodiments, the methods may include acquiring, by a processor via an input system with a bidirectional interface, source data from a plurality of external systems (the source data may include email header feeds, directory listings, access logs, query logs, permission tables, messaging transcripts, and access control rule sets). In some embodiments, the methods may include identifying, by an access control processor executing on the processor, a plurality of roles from directory service entries, a plurality of groups from membership tables, a plurality of privileges from permission tokens, a plurality of control rules from policy statements, and associated time boundaries from validity dates embedded within the permission tokens. In some embodiments, the methods may include calculating, by the processor, access control connections by linking the identified roles, groups, and privileges through common identifiers extracted from the acquired source data. In some embodiments, the methods may include calculating, by the processor, access control weights by applying frequency and sensitivity metrics retrieved from an external regulatory requirement storage component to the calculated access control connections (thereby forming a weighted graph representing a current access privilege landscape). In some embodiments, the methods may include indexing, by an indexing component executing on the processor, each of the identified control rules by assigning a stable reference identifier, indexing calculated access control weights, and indexing calculated access control connections as edge lists representing relationships among roles, groups, and privileges. In some embodiments, the methods may include persisting the indexed control rules in a policy table, the indexed access control weights in a key-value column, and the indexed access control connections in a graph table within a persistent storage component to preserve audit integrity and facilitate rapid retrieval by an access control agent.

In some embodiments, acquiring source data may further include polling each external system at predetermined intervals to update user privilege data periodically. In some embodiments, calculating the access control connections may further include generating logical graph edges between each identified role, group, and privilege based on shared user identifiers. In some embodiments, calculating the access control weights may further include dynamically adjusting numeric values based on changes detected in frequency and sensitivity metrics from the external regulatory requirement storage component. In some embodiments, indexing the control rules may further include generating a mapping structure linking each stable reference identifier to a corresponding control rule for accelerated query performance. In some embodiments, indexing the calculated access control connections may further include representing relationships as edges in a graph-based schema to support graph database queries. In some embodiments, persisting indexed access control weights may include storing numeric weight values keyed to corresponding access control connections in a column-oriented storage system. In some embodiments, the audit logs document changes to indexed control rules, calculated weights, and connections to enable compliance monitoring. In some embodiments, identifying the plurality of privileges may further include verifying validity dates in permission tokens to automatically determine the active or inactive status of associated user privileges.

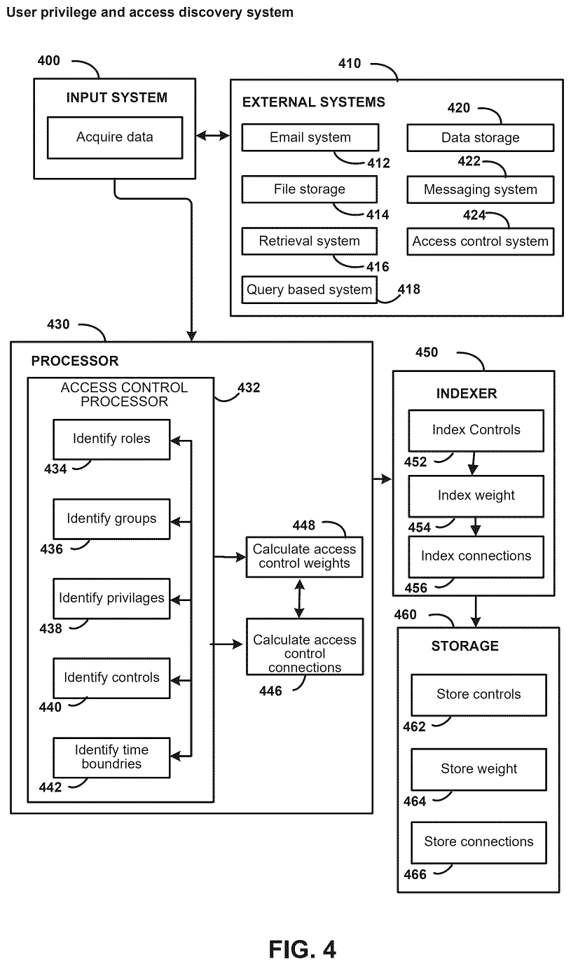

FIG. 4 illustrates a user privilege and access discovery system configured in accordance with some embodiments. In the example illustrated in FIG. 4, the system includes an input system 400, a set of external systems 410, a processor 430, an indexer 450, and a storage component 460. The external systems 410 include an email system 412, a file storage system 414, a retrieval system 416, a query-based system 418, a data storage system 420, a messaging system 422, and an access control system 424. The processor 430 houses an access control processor 432. The access control processor 432 may include modules to identify roles 434, groups 436, privileges 438, controls 440, and time boundaries 442. The processor 430 may include modules to calculate access control connections 446 and access control weights 448. Indexer 450 may include modules to index controls 452, index weight 454, and index connections 456. The storage component 460 may include modules to store controls 462, store weight 464, and store connections 466.

The input system 400 may acquire data from the external systems 410 through a bidirectional interface. The input system 400 may poll an email header feed from the email system 412, a directory listing from the file storage system 414, access logs from the retrieval system 416, query logs from the query-based system 418, permission tables from the data storage system 420, chat transcripts from the messaging system 422, and rule sets from the access control system 424.

The access control processor 432 may identify roles 434 by parsing directory service entries, identify groups 436 by reading membership tables, identify privileges 438 by scanning permission tokens, identify controls 440 by reading policy statements, and identify time boundaries 442 by evaluating validity dates embedded in the tokens. Each identified element may form a record that the processing system may forward to the connection and weight calculation modules.

The processor 430 may calculate access control connections 446 by linking roles groups and privileges through common identifiers and calculate access control weights 448 by applying frequency or sensitivity metrics that originate from the regulation or requirements storage component (e.g., component 110 in FIG. 1, etc.). The resulting weighted graph may represent the current privilege landscape and aligns with the dynamic weighting approach.

The indexer 450 may index controls 452 by assigning a stable reference to each control statement, may index weight 454 by recording the numeric value generated in block 448, and index connections 456 by storing edge lists that connect roles groups and privileges. The index entries may map directly to the storage schema defined for the user access storage component (e.g., component 130 in FIG. 1).

The storage component 460 may store controls 462 in a policy table, store weight 464 in a key-value column, and store connections 466 in a graph table. Persisting these artifacts within the storage system may preserves audit integrity and supports rapid retrieval by the access control agent.

Some embodiments may include methods for automated evaluation and distribution of electronic content, which may include acquiring input data from one or more internal or external sources, classifying, by a classification component executing on the processor, the acquired input data by identifying and assigning attribute labels to extracted attributes within the input data, evaluating, by a regulation agent executing on the processor, the classified attribute labels against weighted regulatory rules stored in a regulatory storage component, and generating a numeric compliance score. In some embodiments, the method may further include evaluating, by an access control agent executing on the processor, the classified attribute labels against privilege matrices retrieved from a user privilege and access discovery system, generating a numeric access score, and evaluating, by a relevance control agent executing on the processor, the classified attribute labels against user preference vectors stored in a user content storage component. In some embodiments, the method may further include generating a numeric relevance score, determining whether to distribute the acquired input data by aggregating the compliance score, access score, and relevance score, and comparing the aggregated result against predefined distribution thresholds. In some embodiments, the method may further include automatically routing, by a distribution component executing on the processor, the acquired input data to designated recipients through a selected communication channel responsive to determining that the aggregated result exceeds the predefined distribution thresholds.

In some embodiments, classifying the acquired input data may further include executing at least one extract processor configured to categorize content attributes from textual or structured data. In some embodiments, generating the numeric compliance score may include calculating a weighted similarity value between attribute labels and stored regulatory rules. In some embodiments, generating the numeric access score may further include calculating a privilege matching value between attribute labels and corresponding privilege matrix entries indicating user roles, groups, and privileges. In some embodiments, generating the numeric relevance score may further include calculating a vector-space similarity between attribute labels and user preference vectors. In some embodiments, determining whether to distribute the acquired input data may further include comparing the aggregated result against separate individual thresholds for compliance, access, and relevance prior to aggregation. In some embodiments, routing the acquired input data may further include transmitting compliant, accessible, and relevant data through the communication channel previously determined by an information gathering agent based on predicted user channel preferences.

Some embodiments may further include, in response to determining the aggregated result does not exceed the predefined distribution thresholds, updating numeric weights utilized by the regulation agent, access control agent, and relevance control agent. Some embodiments may further include persistently storing the updated numeric weights within a dedicated persistent storage system to inform future evaluations performed by evaluation agents. Some embodiments may further include storing detailed records of each evaluation decision, which may include attribute labels, numeric compliance, access, relevance scores, and corresponding distribution decisions, to maintain audit integrity and facilitate rapid retrieval by evaluation agents.

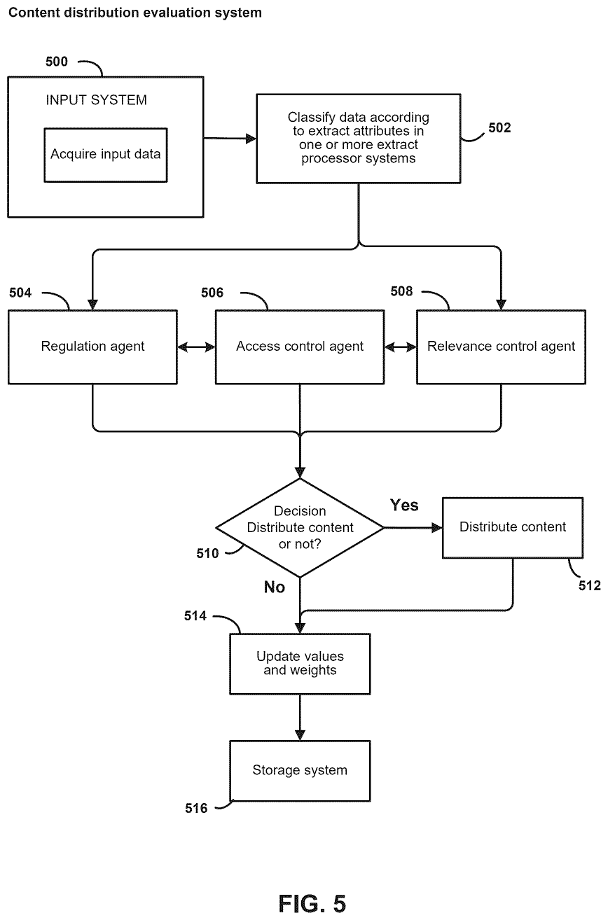

FIG. 5 illustrates a content distribution evaluation system that may be configured for automated evaluation and distribution of electronic content in accordance with some embodiments. In the example illustrated in FIG. 5, the system includes an input system 500, a classification component 502, a regulation agent 504, an access control agent 506, a relevance control agent 508, a decision module 510, a distribution component 512, an update module 514, and a storage system 516.

The input system 500 may acquire input data from internal or external sources and forward the data to a classification component. In block 502, the classification component may classify the input data according to extract attributes produced by one or more extract processors (which, as discussed, may be configured to identify and categorize various aspects of the data). The classification component 502 may attach attribute labels (for use by downstream agents, etc.). In block 504, a regulation agent may compare the classified attributes with weighted regulatory rules obtained from the regulation or requirements storage component (e.g., component 110 of FIG. 1) and output a compliance score. In block 506, a access control agent may compare the same attributes with privilege matrices generated by the user privilege and access discovery system and output an access score. In block 508, a relevance control agent may compare the attributes with user preference vectors stored in the user content storage component (e.g., component 120 of FIG. 1) and output a relevance score.

In determination block 510, the processing system may determine whether to distribute the content based on the received compliance score, access score, and relevance score. The processing system may distribute the content to a distribution component in response to determining that the aggregated result exceeds predefined thresholds. In block 512, the distribution component may route compliant accessible and relevant content to intended recipients through channels selected earlier by the information gathering agent.

In response to determining that the aggregated result does not exceed the thresholds (i.e., determination block 510=“No”), the processing system may direct the flow to an update module. In block 514, the update module may update values and weights that the regulation agent, the access control agent, and the relevance control agent may reference during future evaluations. In block 516, the processing system may write these updates to the storage system, which may persist the updated weights, the evaluation records and the distribution decision (e.g., in the storage system 100 illustrated and described with reference to FIG. 1, etc.).

Some embodiments may include methods for regulatory information analysis and indexing, which may include acquiring regulatory input data from a plurality of external systems, which may include an email system, a messaging system, a file storage system, a retrieval system, a multimedia system, a robotic system, a mobile system, and a network system. In some embodiments, the method may include evaluating, by a pre-processor executed by the processor, each unit of the regulatory input data to determine whether the unit may include a single segment or multiple segments, segmenting the unit into multiple segments in response to a determination that the unit may include multiple segments, and converting each segment of the multiple segments into a normalized uniform format. In some embodiments, the method may include parsing, by a regulatory rule requirement content processor executed by the processor, each segment in normalized uniform format to detect legal clauses and assign preliminary labels to the detected legal clauses. In some embodiments, each preliminary label may indicate an obligation, permission, or prohibition. In some embodiments, the detected legal clauses and assigned preliminary labels may form structured extracts. In some embodiments, the method may include generating, by an indexing module executed by the processor, edge lists connecting the detected legal clauses based on identified relationships, assigning numeric preliminary weights to each connection based on frequency and jurisdiction scope, and embedding textual content of each detected legal clause into a multidimensional vector space to form a semantic index configured to support rapid similarity searches. In some embodiments, the method may include storing, by a storage component executed by the processor, the semantic index, the numeric preliminary weights, the edge lists, and the regulatory input data within persistent storage modules to preserve audit integrity and enable rapid retrieval.

In some embodiments, the processor may acquire the regulatory input data by polling at least one external system at periodic intervals. In some embodiments, the pre-processor may segment the regulatory input data into logical components based on a data type, a content structure, or formatting indicators identified during the evaluation. In some embodiments, the regulatory rule requirement content processor may parse each segment by applying a natural language processing algorithm to identify textual boundaries of each legal clause. In some embodiments, the regulatory rule requirement content processor may assign the preliminary labels to each legal clause by applying a supervised classification algorithm trained on previously labeled regulatory clauses. In some embodiments, the indexing module may generate the edge lists by identifying semantic relationships between the legal clauses through shared terms, citations, or regulatory cross-references. In some embodiments, the indexing module may assign the numeric preliminary weights according to a calculated frequency of occurrence, regulatory priority, or geographic jurisdiction of each legal clause. In some embodiments, the indexing module may embed the textual content of each detected legal clause into the multidimensional vector space through a semantic embedding model trained on regulatory-specific textual data. In some embodiments, the indexing module may assign a unique identifier to each detected legal clause and store each unique identifier in association with textual spans within the semantic index. In some embodiments, the storage component may archive original source texts of the regulatory input data and associate the archived source texts directly with the semantic index and numeric preliminary weights (e.g., for compliance verification or auditing purposes, etc.).

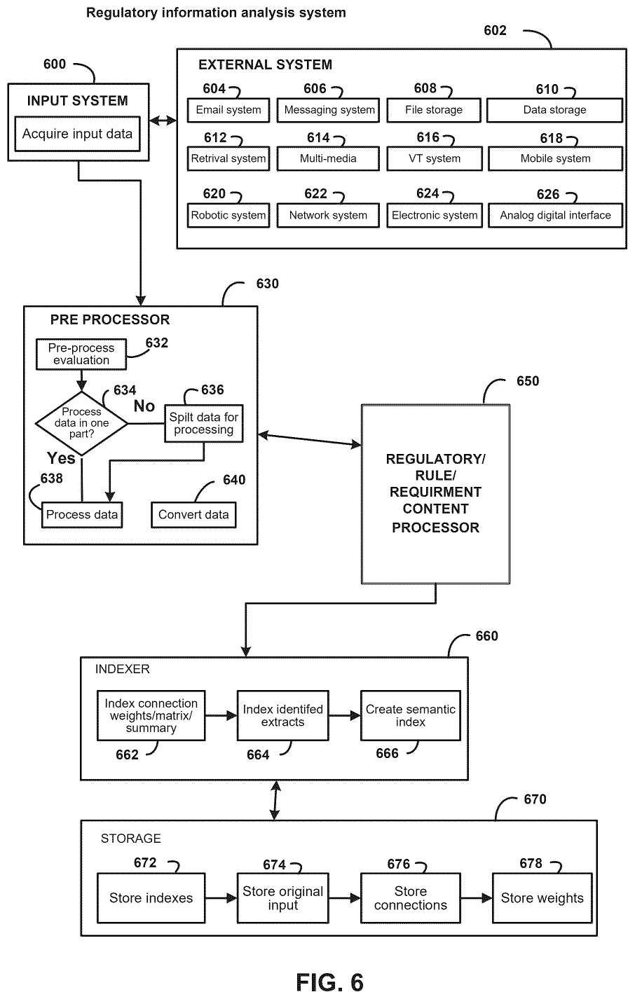

FIG. 6 illustrates a regulatory information analysis system configured in accordance with some embodiments. In the example illustrated in FIG. 6, the system includes an input system 600, an external system block 602, a pre-processor 630, a regulatory rule requirement content processor 650, an indexer 660, and a storage component 670. The external system block 602 may include an email system 604, a messaging system 606, a file storage system 608, a data storage system 610, a retrieval system 612, a multimedia system 614, a virtual terminal system 616, a mobile system 618, a robotic system 620, a network system 622, an electronic system 624, and an analog digital interface 626. The pre-processor 630 may include a pre-process evaluation module 632, a decision branch 634, a split data module 636, a process data module 638, and a convert data module 640. The indexer 660 may include an index connection weights matrix summary module 662, an index identified extracts module 664, and a create semantic index module 666. The storage component 670 may include a store indexes module 672, a store original input module 674, a store connections module 676, and a store weights module 678.

The input system 600 may acquire regulatory input data and exchange the data with the external system block 602 through a bidirectional interface. The input system 600 may pull email messages from the email system 604, chat transcripts from the messaging system 606, file texts from the file storage system 608, table rows from the data storage system 610, search results from the retrieval system 612, audio or video clips from the multimedia system 614, terminal logs from the virtual terminal system 616, handset logs from the mobile system 618, instruction sets from the robotic system 620, packet captures from the network system 622, device logs from the electronic system 624, and waveform samples from the analog digital interface 626.

The pre-processor 630 may perform a pre-process evaluation in module 632 to decide whether to handle the incoming data as a single part. When the decision branch 634 evaluates to yes, the process data module 638 may normalize the data and pass the result to the content processor 650. When the decision branch 634 evaluates to no, the split data module 636 may segment the data, and the convert data module 640 may transform each segment into a uniform format before forwarding the segments to the content processor 650.

The regulatory rule requirement content processor 650 may parse each normalized segment, may detect legal clauses, and assign preliminary labels that correspond to obligations permissions and prohibitions. The processor 650 may output structured extracts that the indexer 660 consumes.

The index connection weights matrix summary module 662 may examine the structured extracts, may generate edge lists that connect related clauses, and compute preliminary weights that reflect clause frequency and jurisdiction scope. The index identified extracts module 664 may attach unique identifiers to each clause and store the identifiers with their textual spans. The create semantic index module 666 may embed the clauses in a vector space and produce a semantic index that supports rapid similarity search.

The store indexes module 672 may persist the semantic index, the store original input module 674 may archive the source texts, the store connections module 676 may record the edge lists that link clauses, and the store weights module 678 may record the numeric weights computed in module 662. The storage component 670 thereby aligns the indexed clauses with their origins as set forth for regulation storage component 110 in FIG. 1.

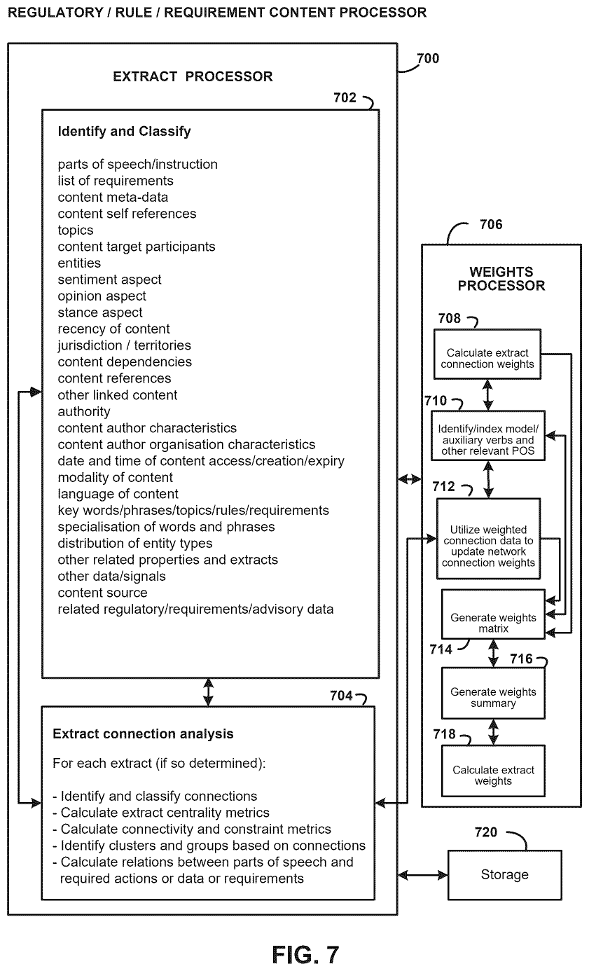

FIG. 7 illustrates a regulatory rule requirement content processor configured in accordance with some embodiments. In the example illustrated in FIG. 7, the system includes an extract processor 700, a weights processor 706, and a storage component 720. The extract processor 700 may include an identify and classify module 702 and an extract connection analysis module 704. The weights processor 706 may include a calculate extract connection weights module 708, an identify or index modal auxiliary verbs module 710, a utilize weighted connection data module 712, a generate weight matrix module 714, a generate weight summary module 716, and a calculate extract weights module 718.

The identify and classify module 702 may inspect each regulatory clause and label parts of speech, requirement lists, meta-data fields, self-references, topics, entities, sentiment aspects, opinion aspects, recency indicators, jurisdictions, dependencies, references, author characteristics, author organization characteristics, access or creation timestamps, content modality, language, key phrases, rule specializations, entity type distributions, and related advisory data. Each label may become an extract record that the module forwards to the extract connection analysis module 704.

The extract connection analysis module 704 may process each extract record. The module may identify connections between clauses, may compute extract centrality metrics, may calculate connectivity and constraint scores, may detect clusters and groups, and derive relationships between parts of speech and required actions or data. The module 704 may forward connection findings to the weights processor 706.

The calculate extract connection weights module 708 may receive connection findings and assign preliminary numeric weights that reflect connection strength. The identify or index modal auxiliary verbs module 710 may parse each clause for auxiliary verbs and other relevant parts of speech and adjust weights when the verbs indicate obligation permission or prohibition. The utilize weighted connection data module 712 may update a network representation that preserves edge strength among clauses.

The generate weight matrix module 714 may consolidate the adjusted weights into a dense matrix suitable for similarity search. The generate weight summary module 716 may produce a compact vector that captures aggregate statistics for fast scoring. The calculate extract weights module 718 may compute a final weight for each clause by combining centrality metrics with verb-based adjustments.

The storage component 720 may store the weights matrix, the weights summary, the final extract weights, and the original connection network for retrieval by a regulation agent (e.g., agent 214 in FIG. 2). The persisted artifacts may align with the regulation or requirements storage component (e.g., component 110 in FIG. 1).

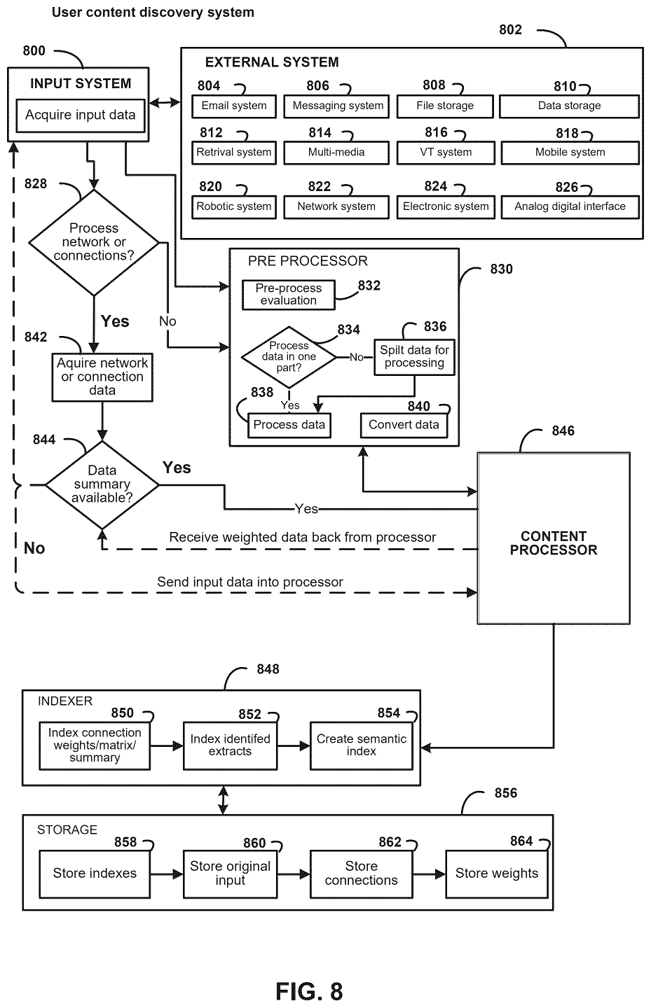

FIG. 8 illustrates a user content discovery system configured in accordance with some embodiments. In the example illustrated in FIG. 8, the system includes an input system 800, an external system block 802, a decision branch 828, a network acquisition module 842, a data summary check 844, a pre-processor 830, a content processor 846, an indexer 848, and a storage component 856. The external system block 802 may include an email system 804, a messaging system 806, a file storage system 808, a data storage system 810, a retrieval system 812, a multimedia system 814, a virtual terminal system 816, a mobile system 818, a robotic system 820, a network system 822, an electronic system 824, and an analog digital interface 826. The pre-processor 830 may include a pre-process evaluation module 832, a decision branch 834, a split data module 836, a process data module 838, and a convert data module 840. The indexer 848 may include an index connection weights matrix summary module 850, an index identified extracts module 852, and a create semantic index module 854. The storage component 856 may include a store indexes module 858, a store original input module 860, a store connections module 862, and a store weights module 864.

The input system 800 may acquire user-generated data, exchange the data with the external system block 802 through a bidirectional interface, and pull message bodies from the email system 804, chat transcripts from the messaging system 806, document texts from the file storage system 808, table rows from the data storage system 810, search results from the retrieval system 812, audio or video clips from the multimedia system 814, terminal logs from the virtual terminal system 816, handset logs from the mobile system 818, motion scripts from the robotic system 820, packet captures from the network system 822, device logs from the electronic system 824, and waveform samples from the analog digital interface 826.

In determination block 828, the processing system may examine incoming metadata to determine whether to process network or connection data. In response to determining to process network or connection data (i.e., determination block 828=“Yes”), the processing system may acquire network or connection data in block 842. In some embodiments, the processing system may pull connection graphs and access edges from the network system 822 and forward weighted network metrics to the indexer 848. In response to determining not to process network or connection data (i.e., determination block 828=“No”), the flow may continue to the pre-processor 830.

In determination block 844, the processing system may perform a data summary check to determine whether a summary of the acquired data already exists. In response to determining a summary of the acquired data that already exists (i.e., determination block 844=“Yes”), check 844 may pass the summary directly to content processor 846. In response to determining no, check 844 may send the raw data to the pre-processor 830.

The pre-process evaluation module 832 may assess data size and heterogeneity. The decision branch 834 may decide whether to process the data in one part. When the branch evaluates to yes, the process data module 838 may normalize the data and forward the result to the content processor 846. When the branch evaluates to no, the split data module 836 may segment the data, and the convert data module 840 may transform each segment into a uniform representation before forwarding the segments to the content processor 846.

Content processor 846 may identify topics, entities, sentiment values, and temporal markers within each segment, and produce structured extracts and weighted vectors that the indexer 848 consumes.

The index connection weights matrix summary module 850 may derive edge lists that connect related extracts and compute preliminary weights that reflect interaction frequency and recency. The index identified extracts module 852 may attach unique identifiers to each extract and store the identifiers with their textual spans. The create semantic index module 854 may embed the extracts in a vector space and produce a semantic index that supports rapid similarity search.

The store indexes module 858 may persist the semantic index, the store original input module 860 may archive the source texts, the store connections module 862 may record the edge lists that link extracts, and the store weights module 864 may record the numeric weights computed in module 850. The storage component 856 thereby aligns user content with the schema of the user content storage component (e.g., component 120 in FIG. 1).

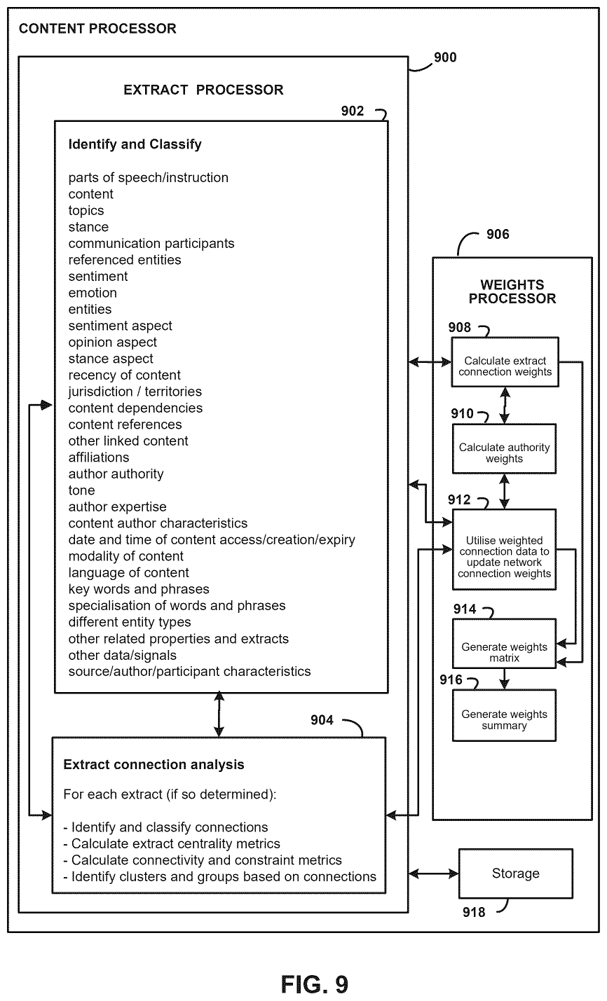

FIG. 9 is a component block diagram that illustrates a content processor 900 suitable for implementing some embodiments. The content processor 900 may coordinate extraction, connection analysis, and weight generation operations that support compliance and relevance evaluation across the wider system.

The content processor 900 may include an extract processor 902, an extract connection analysis module 904, a weights processor 906, and a storage component 918. The extract processor 902 may include an Identify and Classify stage that may label attributes in incoming content. Example attributes include parts of speech or instruction indicators, content topics, stance, communication participants, referenced entities, sentiment, emotion, sentiment aspect, opinion aspect, recency of content, jurisdiction or territories, content dependencies, content references, other linked content, affiliations, author authority, author expertise, content author characteristics, date and time of content access or creation or expiry, modality of content, language of content, key words and phrases, specialization of words and phrases, different entity types, other related properties and extracts, other data or signals, and source or author or participant characteristics. These labels form extract records that flow to the extract connection analysis module 904.

The extract connection analysis module 904 may inspect each extract record, identify and classify connections, calculate extract centrality metrics, calculate connectivity and constraint metrics, and identify clusters and groups based on the detected connections. The extract connection analysis module 904 may output structured connection findings to the weights processor 906.

The weights processor 906 may calculate extract connection weights in block 908, calculate authority weights in block 910, utilize weighted connection data in block 912, generate weight matrix in block 914, and generate weight summary in block 916. For example, in block 908, the processing system may assign preliminary numeric weights that reflect connection strength. In block 910, the processing system may derive numeric values that represent author authority or expertise. In block 912, the processing system may update a network representation that preserves edge strength across extracts. In block 914, the processing system may consolidate adjusted weights into a dense matrix suitable for similarity search. In block 916, the processing system may produce a compact vector that captures aggregate statistics for rapid scoring.

The storage component 918 may persist the weights matrix, the weights summary, the network representation, the extract connection weights, and the authority weights for retrieval by downstream agents such as the regulation agent or the relevance agent.

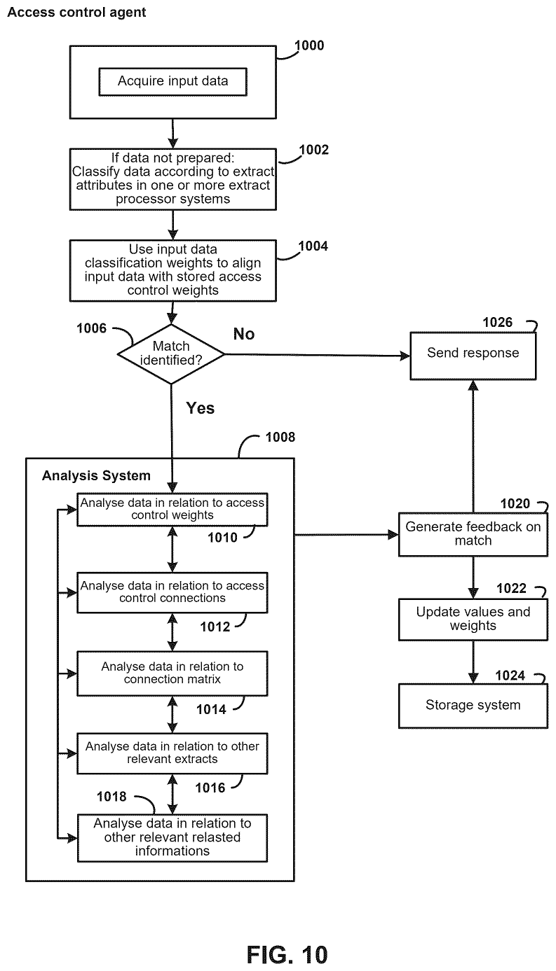

FIG. 10 is a flow diagram that illustrates operations performed by an access control agent (e.g., a software component that evaluates data against privilege rules before distribution) in accordance with some embodiments.

In block 1000, the processing system may acquire input data. For example, the processing system may receive an email body through a HTTPS request, copy the payload into volatile memory, and register a pointer for later evaluation.

In block 1002, the processing system may classify the acquired data according to extract attributes in an extract processor. The extract processing system may be component configured to label textual or binary content with attribute weights that describe topics, entities, and metadata. For example, the processing system may tokenize the email body, assign a topic vector, detect named entities, and write an attribute weight vector to temporary storage.

In block 1004, the processing system may align the attribute weight vector with access control weights stored in a privilege repository. The access control weights may represent numeric privilege values that describe permitted operations for each role. For example, the processing system may calculate similarity metric between the attribute vector and each privilege vector in the repository and select the privilege vector that yields the highest similarity score above a predefined threshold.

In block 1006, the processing system may determine whether the alignment produced a privilege match. When the processing system does not detect a match, flow continues to block 1026. When the processing system detects a match, flow continues to block 1008.

In block 1008, the processing system may enter an analysis system that refines the privilege decision through a sequence of evaluations. The analysis system may be a collection of evaluation modules that apply progressively deeper checks.

In block 1010, the processing system may analyze the data in relation to access control weights. For example, the processing system may sum the weights for each detected attribute and compare the sum to a threshold that applies to the target role.

In block 1012, the processing system may analyze the data in relation to access control connections. The access control connections may be edges in a privilege graph that link roles, groups, and privileges. For example, the processing system may traverse edges from the sender role to the selected privilege and calculate path strength along the traversal.

In block 1014, the processing system may analyze the data in relation to a connection matrix. A connection matrix may include an adjacency matrix that stores numerical edge weights among privilege nodes. For example, the processing system may multiply the attribute vector by the connection matrix and measure the resulting score distribution.

In block 1016, the processing system may analyze the data in relation to other relevant extracts, such as attribute vectors that parallel extract processors have produced for related content such as prior messages in the same thread. For example, the processing system may merge a thread context vector with the current attribute vector and recalculate relevance metrics.

In block 1018, the processing system may analyze the data in relation to other relevant information, which may include contextual data such as timestamp, geographic location, and session metadata. For example, the processing system may confirm that the sender currently holds an active session that includes a multi-factor authentication flag.

In block 1020, the processing system may generate feedback on the privilege match. For example, the processing system may compose a record that contains a confidence score, a rule identifier, and a rationale string and place the record on a feedback queue.

In block 1022, the processing system may update values and weights. For example, the processing system may increment a usage count on the matched privilege vector and adjust edge weights along the traversed path in response to the feedback record.

In block 1024, the processing system may write the updated values and weights to a storage system or persistent memory that holds privilege graphs and audit records. For example, the processing system may execute a Structured Query Language (SQL) insert and commit the transaction to a relational database.

In block 1026, the processing system may send a response or return an access-granted token in response to determining that a match exists or an access-denied message in response to determining that the match evaluation failed.

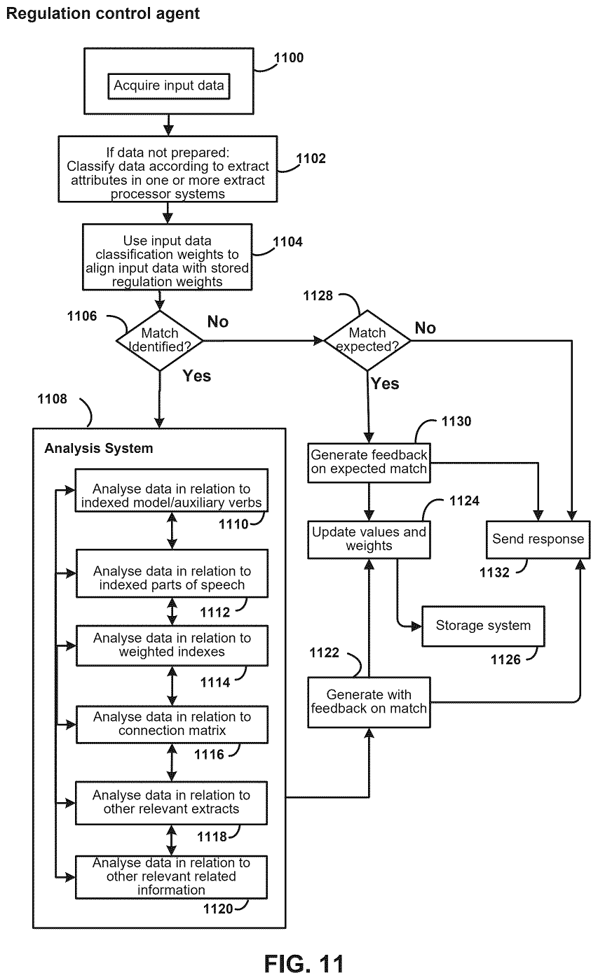

FIG. 11 is a process flow diagram that illustrates a method of evaluating regulatory compliance with a regulation control agent in accordance with some embodiments.

In block 1100, the processing system may acquire input data. For example, the processing system may receive a statutory clause through a Representational State Transfer (REST) Application Programming Interface (API), copy the clause into volatile memory, and assign a pointer for later evaluation.

In block 1102, the processing system may classify the acquired data according to extract attributes in an extract processor, which may be configured to label textual content with attribute weights that describe parts of speech, entities, topics, and metadata. For example, in block 1102 the processing system may apply a transformer encoder to the clause, assign a part-of-speech tag to each token, and produce an attribute weight vector that resides in temporary storage.

In block 1104, the processing system may align the attribute weight vector with regulation weights stored in a rules repository. The regulation weights may represent numeric values that quantify obligation, permission, or prohibition within each clause. For example, in block 1104, the processing system may calculate similarity metric between the attribute vector and each regulation vector in the repository and select the regulation vector that yields a similarity score above a predefined threshold.

In block 1106, the processing system may determine whether the alignment produced a regulation match. A regulation match may be a condition in which the similarity score exceeds the threshold and maps the input clause to a stored rule. When the processing system detects a match, flow continues to block 1108. When the processing system does not detect a match, flow proceeds to block 1128.

In block 1108, the processing system may enter an analysis system that refines the rule decision through a sequence of evaluations. The analysis system may be a collection of evaluation modules that apply progressively deeper checks on linguistic and structural features.

In block 1110, the processing system may analyze the data in relation to indexed modal auxiliary verbs, such as may or shall. For example, the processing system may detect “shall” in the clause, look up a modality weight of 0.9, and adjust the regulation match score.

In block 1112, the processing system may analyze the data in relation to indexed parts of speech. A part-of-speech index may include a table that records frequency and positional statistics for nouns, verbs, adjectives, and other grammatical categories. For example, the processing system may compare the distribution of nouns and verbs in the clause to historical patterns and adjust confidence when the distribution deviates from the pattern.

In block 1114, the processing system may analyze the data in relation to weighted indexes, each of which may be a vector that summarizes term importance across a corpus of regulatory documents. For example, the processing system may multiply the clause term vector by the weighted index and add the result to the match score.

In block 1116, the processing system may analyze the data in relation to a connection matrix, which may be an adjacency matrix that stores numeric edge weights among rules that share cross-references. For example, the processing system may retrieve a column that links the clause to related rules and measure aggregate edge weight.

In block 1118, the processing system may analyze the data in relation to other relevant extracts, such as attribute vectors that parallel extract processors have produced for related clauses in the same regulation. For example, the processing system may merge a section context vector with the current attribute vector and recalculate the match score.

In block 1120, the processing system may analyze the data in relation to other relevant information, which may include contextual data such as jurisdiction, enforcement date, and document version. For example, the processing system may confirm that the clause applies to the jurisdiction specified in the user request and adjust confidence accordingly.

In block 1122, the processing system may generate feedback on the regulation match. For example, the processing system may compose a record that contains a confidence score, a rule identifier, and an explanatory string and place the record on a feedback queue.

In block 1124, the processing system may update values and weights. For example, the processing system may increment a clause frequency counter in the rules repository and adjust edge weights in the connection matrix in response to the feedback record.

In block 1126, the processing system may write the updated values and weights to a storage system. A storage system may include persistent memory that holds rule graphs and audit records. For example, the processing system may execute a SQL update and commit the transaction to a relational database.

In block 1128, the processing system may decide whether a match ought to exist according to prior expectations. A match expectation may include a metadata flag that indicates the clause should map to a stored rule. When the processing system detects that a match ought to exist, flow continues to block 1130; otherwise, flow proceeds to block 1132.

In block 1130, the processing system may generate feedback on the missing match. For example, the processing system may create an alert that notes the expected rule identifier, the unmatched clause, and the gap reason code.

In block 1132, the processing system may send a response. For example, the processing system may return a compliance-passed token when a match holds or a compliance-flagged message when no match holds.

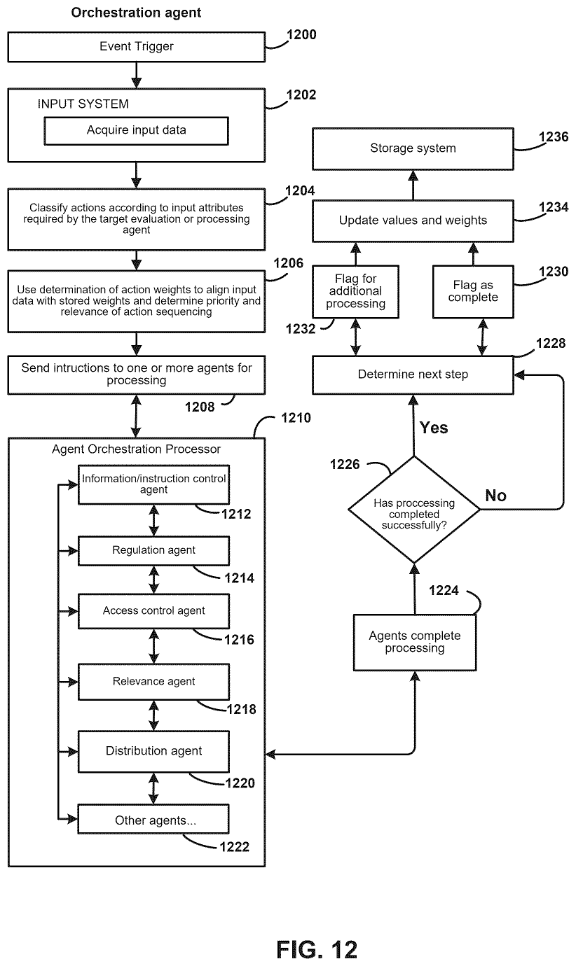

FIG. 12 is a process flow diagram that illustrates a method of orchestrating multi-agent data acquisition, attribute classification, priority assessment, and content distribution within a communication and data transfer environment in accordance with some embodiments.

In block 1200, the processing system may detect an event trigger (e.g., a signal that prompts orchestration operations, etc.). In some embodiments, the processing system may poll a message queue for a content-arrival notification and compare the notification to a rule table that specifies which events start an orchestration cycle.

In block 1202, the processing system may acquire input data through an input system, which may include hardware and/or software resources that ingest data from internal or external sources. For example, the processing system may receive a JavaScript Object Notation (JSON) payload through a HTTPS request, copy the payload into volatile memory, and attach a transaction identifier.

In block 1204, the processing system may classify actions according to input attributes referenced by a target evaluation agent. The classification operations may include attaching attribute weights that describe topics, entities, and urgency. In some embodiments, the processing system may tokenize a text field, detect a named entity that denotes a jurisdiction, assign a jurisdiction weight, and store the weight vector in temporary memory.

In block 1206, the processing system may align the attribute weight vector with stored agent weights and determine priority and relevance of action sequencing. The alignment operations may include calculating similarity between the attribute vector and precomputed agent vectors. In some embodiments, the processing system may calculate similarity metric between the attribute vector and a regulation agent vector and assign a ranking score.

In block 1208, the processing system may send instructions to one or more agents for processing. Each instruction may identify the target agent, input location, and expected output. In some embodiments, the processing system may place a tuple (e.g., agent ID, data pointer, deadline, etc.) on an inter-agent bus that supports asynchronous delivery.

In block 1210, the processing system may invoke an agent orchestration processor that coordinates agent execution. The agent orchestration processing system may be a control module that sequences specialized agents. The processing system may include an information or instruction control agent 1212 that validates prompts, a regulation agent 1214 that evaluates compliance, an access control agent 1216 that verifies privilege, a relevance agent 1218 that measures pertinence, a distribution agent 1220 that routes content, and other agents 1222 that perform auxiliary tasks. In some embodiments, the processing system may call the regulation agent first when the attribute vector carries a high compliance weight.

In block 1224, the processing system may record that the agents complete processing (e.g., based on receipt of success codes from each engaged agent, etc.). In some embodiments, the processing system may wait until the regulation agent returns a compliance-passed flag, the access control agent returns an access-granted flag, and the distribution agent returns a delivery-confirmed flag.

In block 1226, the processing system may determine whether processing completed successfully, which may include monitoring to detect a condition in which each engaged agent returns a success code. When success occurs, flow continues to block 1228. When success does not occur, flow continues to block 1232.

In block 1228, the processing system may determine the next step, which may include referencing policy tables that map success outcomes to follow-on actions. For example, the processing system may choose to archive results or to notify a report generator.

In block 1230, the processing system may flag the transaction as complete, which may include writing a completion marker to a status table. For example, the processing system may insert a row that contains the transaction identifier and a “complete” status value.

In block 1232, the processing system may flag the transaction for additional processing. The flag indicates that an agent returned a retriable error. For example, the processing system may insert a row that contains the transaction identifier and a “retry” status value.

In block 1234, the processing system may update values and weights. Updates adjust weight vectors and counters that guide future alignment operations. For example, the processing system may increment an error counter for the agent that produced the retry flag and lower the corresponding agent priority weight.

In block 1236, the processing system may write the updated values and flags to a storage system. A storage system may include persistent memory resources that maintain weight vectors, audit logs, and status tables. For example, the processing system may execute SQL updates that persist the new priority weights and status markers in a relational database.

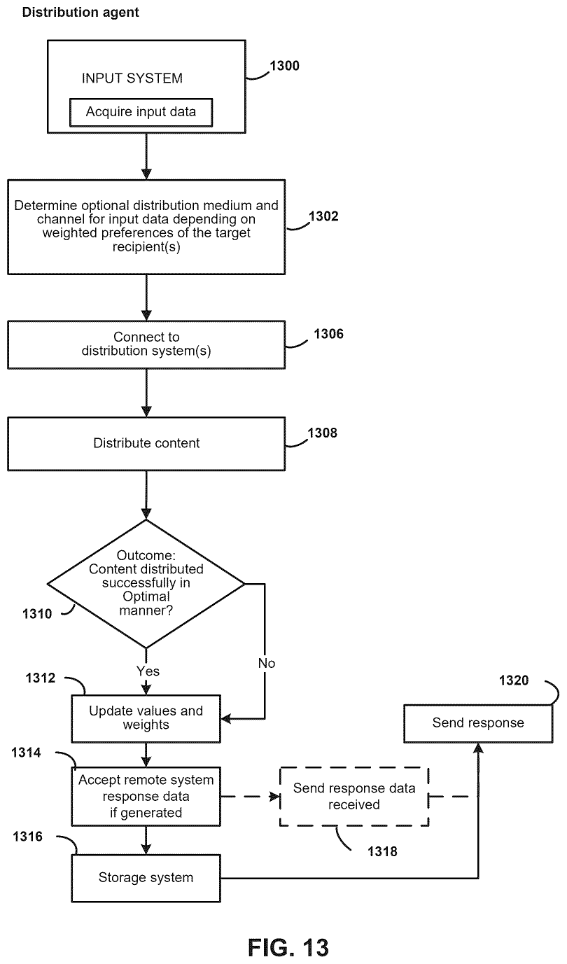

FIG. 13 is a process flow diagram that illustrates a method of distributing evaluated content and capturing remote response data in accordance with some embodiments.

In block 1300, the processing system may acquire input data through an input system. An input system denotes hardware and software components that ingest content from internal sources or external sources. For example, the processing system may read a JSON record from a message queue, copy the record into volatile memory, and attach a transaction identifier for traceability.

In block 1302, the processing system may determine an optimal distribution medium and channel for the input data by consulting weighted preferences of each target recipient. The distribution medium may be an electronic pathway such as email, Short Message Service (SMS), or a HTTPS application-programming-interface endpoint. For example, the processing system may resolve that Recipient A prefers dashboard notification when the urgency weight exceeds a threshold, while Recipient B prefers email when the sensitivity weight remains below the threshold.

In block 1306, the processing system may connect to one or more distribution systems. The distribution system may be an external service that transmits content to recipients. For example, the processing system may perform a Transport Layer Security handshake with an email gateway, authenticate with an OAuth token, and open a mail submission session.

In block 1308, the processing system may distribute the content through the selected distribution systems. For example, the processing system may transmit the email body, an attachment hash, and routing metadata to the email gateway and record a success code that the gateway returns.

In block 1310, the processing system may evaluate the outcome by comparing returned status data with predefined success criteria. The decision branch may determine whether the content reached the recipients through the preferred channel within a latency target.

In block 1312, the processing system may update values and weights in response to determining that the distribution was successful. For example, the processing system may increment a reliability counter for the chosen channel and raise the channel priority weight linked to the recipient profile.

In block 1314, the processing system may accept remote system response data when the distribution system generates feedback. The remote system response data may include acknowledgments or error messages returned by endpoints such as read-receipts or bounce codes. For example, the processing system may parse a simple mail transfer protocol bounce notice, extract a reason code, and attach the code to the transaction record.

In block 1316, the processing system may write the updated values, weights, and any captured response data to a storage system or persistent memory that maintains weight vectors, audit logs, and status records. For example, the processing system may execute SQL insert statements that store the new channel weights and the bounce reason code in relational tables.

In block 1318, when remote response data exists, the processing system may include that data in a composite result object that travels to downstream agents. For example, the processing system may embed the bounce reason code within a JSON field and forward the object to a report generation agent.

In block 1320, the processing system may send a response that summarizes the distribution outcome. For example, the processing system may return an access-granted token, a delivery-confirmed flag, and the composite result object when remote response data accompanies the success codes or may return an access-granted token and a delivery-failed flag when the decision branch in block 1310 denotes failure.

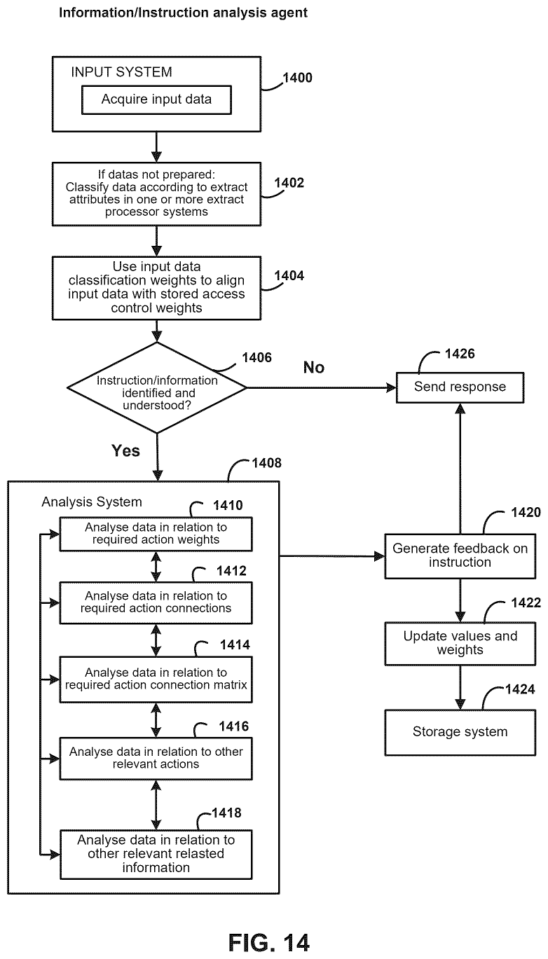

FIG. 14 is a process flow diagram that illustrates a method of analysing instructions, aligning those instructions with stored action weights, and generating feedback through an information instruction analysis agent in accordance with some embodiments.

In block 1400, the processing system may acquire input data through an input system. For example, the processing system may read a JavaScript Object Notation payload from a message queue and place the payload in volatile memory together with a transaction identifier.

In block 1402, the processing system may classify the acquired data according to extract attributes in an extract processor, which may be configured to assign attribute weights that describe topics, entities, and intent. For example, the processing system may tokenize a sentence, detect imperative mood, and assign an intent weight that equals 0.87.

In block 1404, the processing system may align the attribute weight vector with access control weights stored in a privilege repository. Access control weights may represent numeric values that quantify permissions for actions. For example, the processing system may compute similarity metric between the vector and each privilege vector and choose the privilege vector that produces the highest similarity score above 0.75.

In block 1406, the processing system may evaluate whether the instruction or information has been identified and understood. These operations may include mapping the data to a known instruction class (for identification) and reaching a similarity score that exceeds a comprehension threshold (for understanding). The evaluation may direct flow to block 1408 when identification holds or to block 1426 when identification fails.

In block 1408, the processing system may enter an analysis system that refines the interpretation of the instruction. In some embodiments, the analysis system may include sequential evaluation modules.

In block 1410, the processing system may analyze the data in relation to required action weights. The action weights may represent numeric values that reflect regulatory or policy urgency. For example, the processing system may measure the sum of imperative verb weights and compare the sum with a dispatch threshold.

In block 1412, the processing system may analyze the data in relation to required action connections. The action connections may be edges that link an instruction to related actions in a privilege graph. For example, the processing system may trace an edge from “approve expenditure” to “notify finance” and evaluate edge strength that equals 0.62.

In block 1414, the processing system may analyze the data in relation to a required action connection matrix, which may be an adjacency matrix that stores numeric edge weights among action nodes. For example, the processing system may multiply the attribute vector by the matrix and inspect the resulting distribution to detect secondary actions.

In block 1416, the processing system may analyze the data in relation to other relevant actions, which may include instructions previously processed within the same thread. For example, the processing system may merge a historical vector that represents “request budget” and recalculate priority.

In block 1418, the processing system may analyze the data in relation to other relevant information, which may include contextual data such as timestamp, jurisdiction, or document version. For example, the processing system may confirm that the instruction falls within an active fiscal year.

In block 1420, the processing system may generate feedback on the instruction. The feedback may include a confidence score, a rule identifier, and a rationale string. For example, the processing system may write “0.91, budgetApprovalRule-17, urgency confirmed” to a feedback queue in block 1420.

In block 1422, the processing system may update values and weights. For example, the processing system may increment a usage counter for the budget approval rule and adjust the edge weight that links approval to notification.

In block 1424, the processing system may write the updated values and weights to a storage system or persistent memory that records rule graphs and audit logs. For example, the processing system may execute SQL insert statements that store the new edge weight and the updated usage counter.

In block 1426, the processing system may send a response to the caller. For example, the processing system may return an “instruction-processed” token when identification holds or an “instruction-unresolved” token when identification fails.

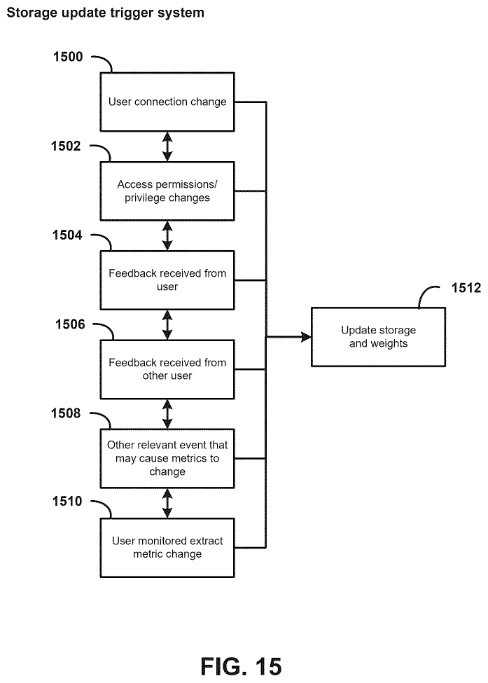

FIG. 15 is a process flow diagram that illustrates a method of updating storage values and weight metrics in response to connection changes, permission modifications, user feedback, and monitored extract variations in accordance with some embodiments.

In block 1500, the processing system may detect a user connection change. For example, the processing system may observe a new link in a collaboration graph and compare the link strength to a threshold to decide that the graph warrants a weight adjustment.

In block 1502, the processing system may detect an access permission or privilege change. For example, the processing system may receive an identity-and-access-management notification that grants a role to a user and append the role identifier to a privilege table that guides compliance logic.

In block 1504, the processing system may receive feedback from the user. For example, the processing system may parse a satisfaction score that the user enters into a dashboard and assign the score to a relevance metric.

In block 1506, the processing system may receive feedback from another user. For example, the processing system may store a peer review comment that criticizes document clarity and flag the document for follow-up analysis.

In block 1508, the processing system may register another relevant event that alters metrics. For example, the processing system may capture a system performance alert that reports elevated latency and lower a freshness weight linked to a data source.

In block 1510, the processing system may detect a user-monitored extract metric change. A user-monitored extract metric may be a numerical signal that the user selects for continuous observation. For example, the processing system may notice that a sentiment score for a topic exceeds or drops below a watch threshold.

In block 1512, the processing system may update storage and weights. For example, the processing system may write revised privilege weights, relevance scores, and freshness metrics to a columnar database that supports rapid vector queries.

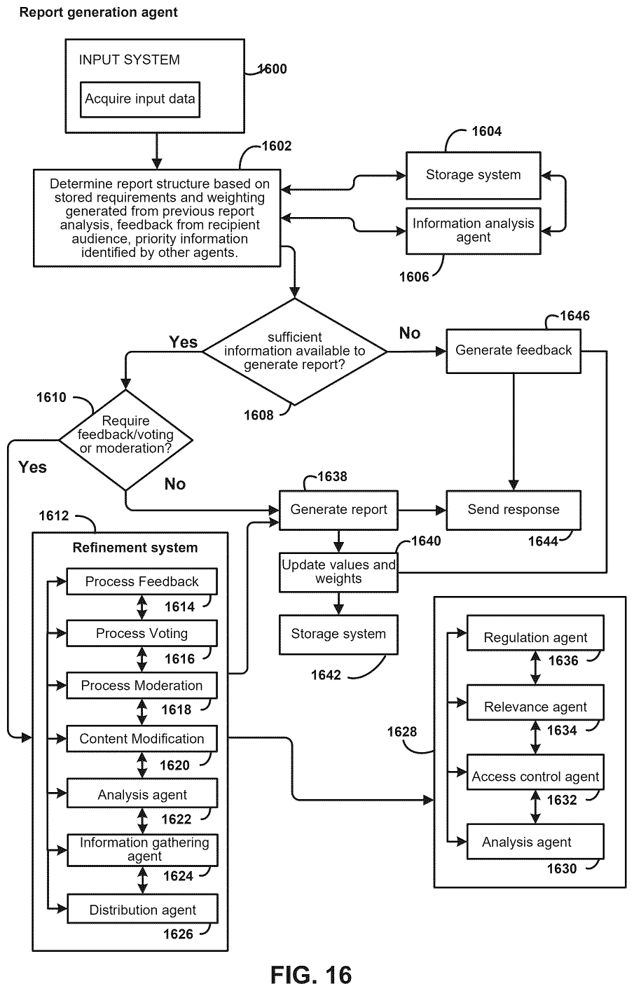

FIG. 16 is a process flow diagram that illustrates a method of generating, refining, and distributing structured reports through coordinated operations among multiple agents in accordance with some embodiments.

In block 1600, the processing system may acquire input data through an input system. For example, the processing system may read a comma-separated-value file from a secure file transfer protocol endpoint and store the file in volatile memory with a transaction identifier.

In block 1602, the processing system may determine a report structure based on stored requirements, weighting derived from previous report analysis, feedback from recipients, and priority information identified by other agents. For example, the processing system may retrieve a template identifier from a template library, rank candidate sections with a priority vector, and select the top five sections for inclusion.

In block 1604, the processing system may retrieve historical weights and requirement rules from a storage system. For example, the processing system may issue a SQL select statement that returns the relevance weight for each template section.

In block 1606, the processing system may ingest analytic findings from an information analysis agent. An information analysis agent may include a module that summarizes current data trends. For example, the processing system may merge a trend vector that ranks sales growth with the template weight vector.

In block 1608, the processing system may decide whether sufficient information exists to generate the report. The decision compares section coverage against a completeness threshold. Flow follows the affirmative branch when coverage meets the threshold or follows the negative branch when coverage falls short.

In block 1610, the processing system may determine whether feedback, voting, or moderation will refine the draft report. The decision reads a policy flag that indicates whether stakeholder review precedes publication.

In block 1612, the processing system may enter a refinement system when the policy flag calls for review. A refinement system may include a pipeline that processes feedback, voting, moderation, and content changes.

In block 1614, the processing system may process feedback. For example, the processing system may aggregate reviewer comments, classify sentiment, and assign a correction weight to each paragraph.

In block 1616, the processing system may process voting. For example, the processing system may tally approval votes for each section and compute a rank order.

In block 1618, the processing system may process moderation. For example, the processing system may remove prohibited terms that a moderation rule table lists for the target audience.

In block 1620, the processing system may perform content modification. For example, the processing system may rewrite passive sentences into active form and update numerical values with revised figures from a data feed.

In block 1622, the processing system may invoke an analysis agent to reassess updated content. An analysis agent may include a module that measures compliance, relevance, and clarity. For example, the processing system may calculate a readability score and compare the score to a readability threshold.

In block 1624, the processing system may invoke an information gathering agent to collect supplemental data. For example, the processing system may query an external analytics API for up-to-date market share values.

In block 1626, the processing system may invoke a distribution agent to prepare delivery channels for the final report. For example, the processing system may schedule an email batch and a dashboard post with the same content identifier.

In block 1628, the processing system may consult specialized agents that provide compliance, relevance, access control, and analytic validation. Blocks 1630 through 1636 represent those specialized agents. For example, the regulation agent in block 1636 may confirm that the report omits restricted terms, the relevance agent in block 1634 may confirm that the report matches audience interests, the access control agent in block 1632 may verify recipient privileges, and the analysis agent in block 1630 may recompute confidence metrics.

In block 1638, the processing system may generate the report. For example, the processing system may merge the selected template sections, embed updated charts, and render a portable document format file.

In block 1640, the processing system may update values and weights. For example, the processing system may raise the relevance weight of a section that received unanimous approval votes.

In block 1642, the processing system may store the updated weights, feedback records, and the final report in a storage system. For example, the processing system may write a binary large object that contains the report file and an associated metadata row that records section weights.

In block 1644, the processing system may send a response to the calling component. For example, the processing system may return a uniform resource locator that references the stored report and a success flag that denotes completion.

In block 1646, the processing system may generate feedback when the information sufficiency decision in block 1608 returns a negative result. For example, the processing system may assemble a missing-data list and attach recommended data sources for each missing field.

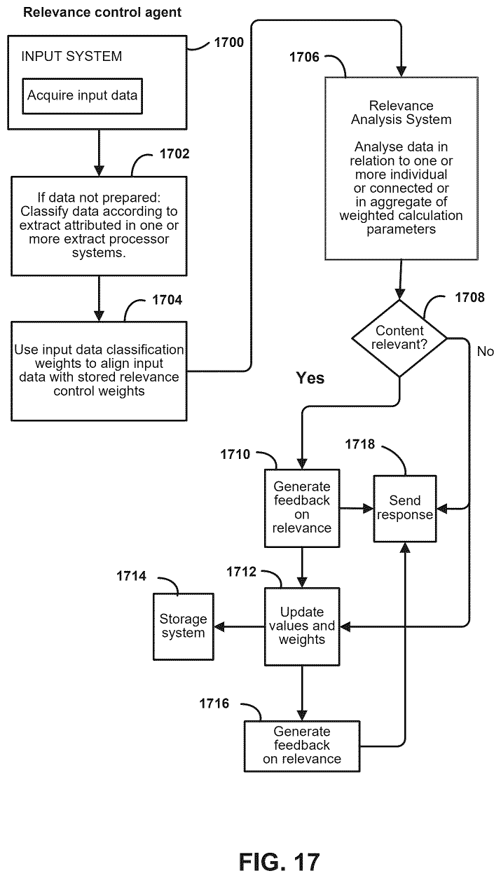

FIG. 17 is a process flow diagram that illustrates a method of evaluating content relevance with a relevance control agent in accordance with some embodiments.

In block 1700, the processing system may acquire input data through an input system. For example, the processing system may accept a JASON payload from an event queue, copy the payload into volatile memory, and assign a transaction identifier for traceability.

In block 1702, the processing system may classify the acquired data according to extract attributes in an extract processor, which may be configured to assign attribute weights for topics, entities, sentiment, and intent. For example, the processing system may tokenize a paragraph, identify a project identifier, and assign a project relevance weight that equals 0.78.

In block 1704, the processing system may align the attribute weight vector with relevance control weights stored in a relevance repository. The relevance control weights may represent numeric values that quantify pertinence for each recipient. For example, the processing system may compute similarity metric between the attribute vector and each relevance vector in the repository and select the relevance vector that yields the highest similarity score above 0.70.

In block 1706, the processing system may analyze the data within a relevance analysis system. A relevance analysis system may include a set of evaluation routines that measure contribution from individual weighted calculation parameters and from aggregates of those parameters. For example, the processing system may inspect sentiment polarity, topical overlap, and prior engagement frequency and calculate a composite relevance score.

In block 1708, the processing system may decide whether the content remains relevant. Relevance may include a composite score that exceeds a relevance threshold. The decision directs flow to block 1710 when relevance holds or to block 1718 when relevance fails.

In block 1710, the processing system may generate feedback on relevance. The feedback includes a confidence score, a recipient identifier, and a rationale string. For example, the processing system may write “0.85, recipient-42, topic alignment confirmed” to a feedback queue.

In block 1712, the processing system may update values and weights. For example, the processing system may raise the topical weight for the recipient because the recipient opened similar content during the past week.

In block 1714, the processing system may write updated weights and feedback records to a storage system. A storage system denotes persistent memory that stores relevance graphs and audit logs. For example, the processing system may execute Structured Query Language insert statements that persist the new topical weight and the feedback record.

In block 1716, the processing system may generate additional feedback on relevance for higher-level agents that monitor trend data. For example, the processing system may aggregate confidence scores from multiple recipients and produce a relevance trend vector.

In block 1718, the processing system may send a response. For example, the processing system may return a relevance-passed token when relevance holds or a relevance-low token when relevance fails.

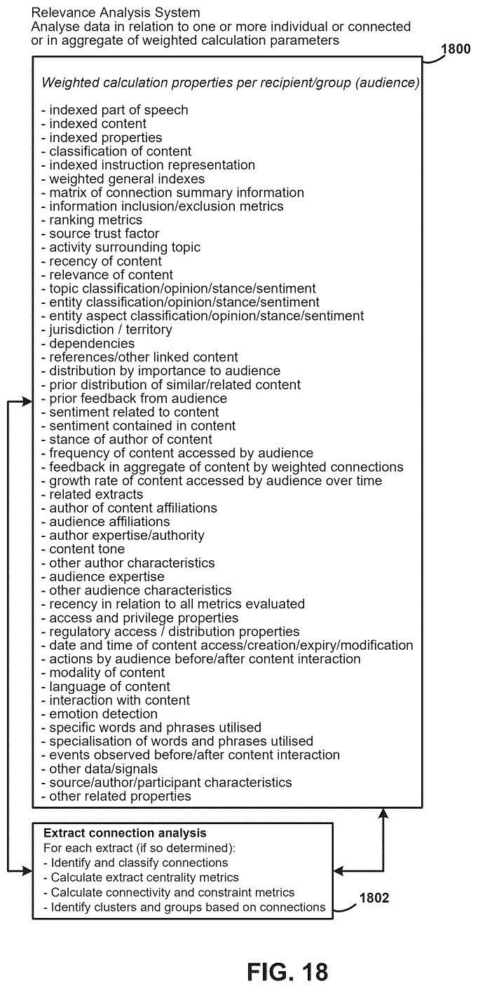

FIG. 18 is a process flow diagram that illustrates a method of computing weighted relevance metrics within a relevance analysis system in accordance with some embodiments.

In block 1800, the processing system may evaluate input data against weighted calculation properties for each recipient group. Weighted calculation properties include indexed parts of speech, indexed content classes, general indexes, instruction inclusion metrics, ranking metrics, source trust factors, topical activity measures, recency indicators, jurisdiction markers, dependency graphs, reference links, distribution history, prior feedback scores, sentiment values, audience expertise, access privileges, regulatory restrictions, audience affiliations, language markers, interaction metrics, modality flags, specialized vocabulary usage, event logs, and other data signals. For example, the processing system may compute a recency weight that equals 0.82, a source trust weight that equals 0.90, and a sentiment weight that equals 0.65, and combine these values through a weighted sum to form a preliminary relevance score.

In block 1802, the processing system may extract connection analysis for each extract that possesses sufficient metadata. Extract connection analysis may include a procedure that identifies and classifies connections among extracts, calculates extract centrality metrics, calculates connectivity and constraint metrics, and identifies clusters and groups based on the detected connections. For example, the processing system may detect that two policy updates share identical jurisdiction tags, assign a centrality value that equals 0.73, and cluster the updates under a “regulatory compliance” node.

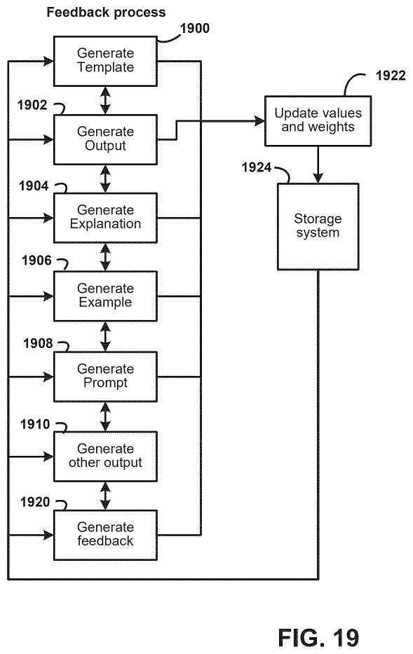

FIG. 19 is a process flow diagram that illustrates a method of generating structured feedback and updating relevance or compliance weights in accordance with some embodiments.

In block 1900, the processing system may generate a feedback template. A feedback template may include a predefined textual scaffold that reserves slots for explanations, examples, and prompts. For example, the processing system may create a template that contains Markdown headings for “Observation,” “Explanation,” and “Next Action.”

In block 1902, the processing system may generate output that populates the template slots with content-specific values. For example, the processing system may insert “Low sentiment polarity detected” into the Observation slot.

In block 1904, the processing system may generate an explanation. An explanation may include a natural-language paragraph that justifies a metric adjustment. For example, the processing system may state that a decline in sentiment weight links to negative user surveys.

In block 1906, the processing system may generate an example or a concrete or practical instance that illustrates the explanation. For example, the processing system may quote a negative comment from a survey response.

In block 1908, the processing system may generate a prompt, which may include a question or instruction that requests user confirmation or additional data. For example, the processing system may ask “Confirm priority adjustment for topic X?”

In block 1910, the processing system may generate other output when the template defines additional slots, such as figures, tables, or code snippets that support the explanation. For example, the processing system may embed a bar chart that shows weekly sentiment averages in block 1910.

In block 1920, the processing system may generate feedback by assembling the populated template. For example, the processing system may merge the observation, explanation, example, prompt, and chart into an HTML document.

In block 1922, the processing system may update values and weights based on the generated feedback or subsequent user responses. For example, the processing system may decrease the relevance weight for the topic under review and increase the monitoring frequency weight.

In block 1924, the processing system may write the updated values, weights, and feedback document to a storage system or persistent memory that stores feedback archives, weight vectors, and audit logs. For example, the processing system may store the HTML document in an object store and store the new weight values in a graph database.

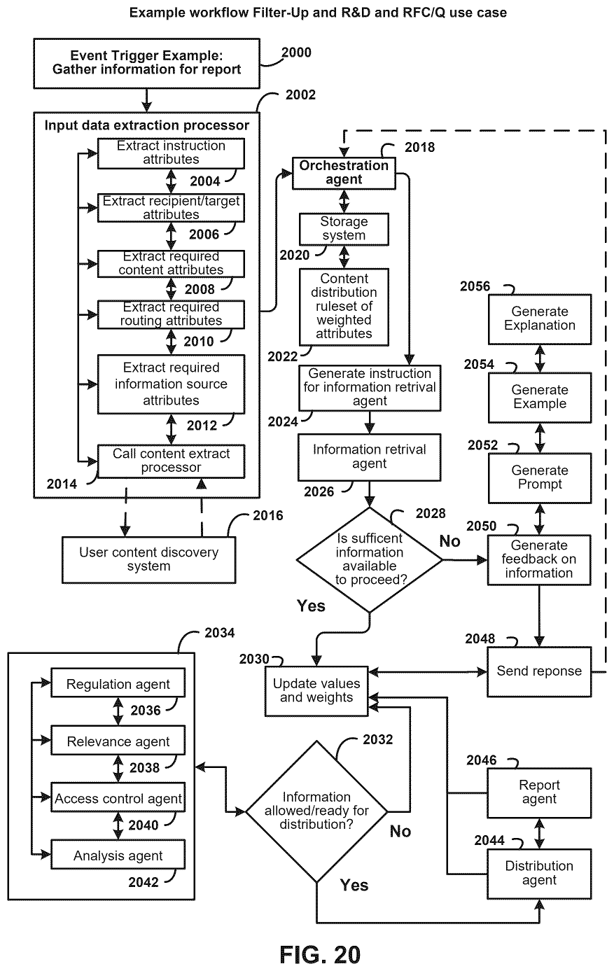

FIG. 20 is a process flow diagram that illustrates a method of coordinating information gathering, attribute extraction, orchestration, and distribution decisions for a reporting use case in accordance with some embodiments.

In block 2000, the processing system may detect an event trigger that requests information gathering for a report. For example, the processing system may listen on a scheduling queue and receive a message that references a quarterly research update.

In block 2002, the processing system may enter an input data extraction processor. For example, the processing system may copy instruction data into volatile memory and assign a transaction identifier.

In block 2004, the processing system may extract instruction attributes such as requested report type or deadline. For example, the processing system may parse the subject line “R&D Filter-Up Summary” and assign a type weight that equals 0.82.

In block 2006, the processing system may extract recipient attributes, which may include metadata that identifies target readers. For example, the processing system may detect a distribution list named “Executive-R&D” and record an audience expertise weight that equals 0.90.

In block 2008, the processing system may extract content attributes that describe subject-matter topics. For example, the processing system may detect the phrase “RFC/Q” and map that phrase to a topic code “Regulatory Funding Cycle.”

In block 2010, the processing system may extract routing attributes that guide a distribution agent. For example, the processing system may note that secure email represents the preferred channel and assign a routing priority weight that equals 0.75.

In block 2012, the processing system may extract information source attributes, which may be an external database or file store that hosts relevant material. For example, the processing system may identify a research repository path and save the path for retrieval.

In block 2014, the processing system may call a content extract processor that fetches supplementary data. For example, the processing system may query the research repository with a keyword vector derived from the topic code.

In block 2016, the processing system may consult a user content discovery system to retrieve prior content that aligns with the same topic. For example, the processing system may return three prior RFC/Q summaries published during the past year.

In block 2018, the processing system may invoke an orchestration agent that manages agent interactions. For example, the orchestration agent may choose a relevance agent first when the audience expertise weight remains high.

In block 2020, the orchestration agent may retrieve routing rules and weighted attributes from a storage system. For example, the orchestration agent may pull template weights that match the report type.

In block 2022, the orchestration agent may consult a content distribution ruleset of weighted attributes. For example, the agent may verify that secure email channel weight exceeds a minimum threshold for executive content.

In block 2024, the orchestration agent may generate an instruction for an information retrieval agent. The instruction specifies query parameters and expected document formats. For example, the instruction may request patent-landscape PDFs linked to the topic code.

In block 2026, the information retrieval agent may gather external documents. For example, the retrieval agent may authenticate a patent database, execute the query, and return document handles.

In block 2028, the processing system may decide whether sufficient information remains available. Sufficiency may include meeting completeness metrics for each required section. Flow continues to block 2050 when sufficiency fails or to block 2030 when sufficiency holds.

In block 2030, the processing system may update values and weights. For example, the processing system may raise the trust weight for the patent database because the retrieval agent returned valid documents.

In block 2032, the processing system may decide whether information may be distributed. The decision references access policies checked by downstream agents. In block 2034, the processing system may consult specialized agents. Blocks 2036 through 2042 denote the regulation agent, the relevance agent, the access control agent, and the analysis agent. Each agent may output a decision vector.

In block 2044, the processing system may pass compliant content to a distribution agent when the access control agent returns a grant code.

In block 2046, the processing system may invoke a report agent that assembles the final document. For example, the report agent may merge extracted data with a template and render a portable document format file.

In block 2048, the processing system may send a response to the caller that confirms report generation. For example, the response may include a download link.

In block 2050, the processing system may generate feedback on information sufficiency when block 2028 returns negative. For example, the feedback may list missing data fields.

In block 2052, the processing system may generate a prompt that requests additional material. For example, the prompt may read “Provide current quarter R&D spend.”

In block 2054, the processing system may generate an example that clarifies the requested format. For example, the system may include “Example: USD 3.4 million” within the prompt.

In block 2056, the processing system may generate an explanation that justifies the data request. For example, the explanation may state that the budget section lacks monetary figures and that the report cannot proceed without that value.

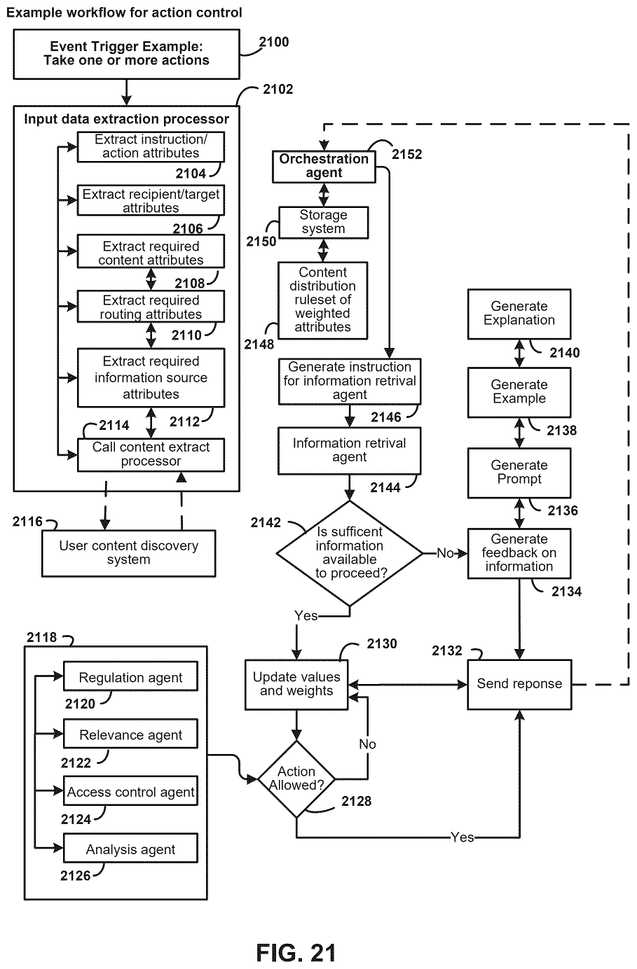

FIG. 21 is a process flow diagram that illustrates a method of controlling action execution through attribute extraction, orchestration, and policy validation in accordance with some embodiments.

In block 2100, the processing system may monitor and detect an event trigger that requests one or more actions. In block 2102, the processing system may enter an input-data extraction processor configured for action attributes. In some embodiments, the input-data extraction processing system may be a component or module that parses raw instructions into attribute vectors. In some embodiments, the processing system may segment the message into tokens and store the tokens in a staging buffer.

In block 2104, the processing system may extract instruction-action attributes such as verbs and urgency levels. For example, the processing system may detect the phrase “deploy prototype” and assign an urgency weight that equals 0.88 to the attribute vector.

In block 2106, the processing system may extract recipient attributes, which may include metadata that identifies target performers. For example, the processing system may map the label “deployment team” to a role weight that equals 0.80.

In block 2108, the processing system may extract content attributes that describe action context. For example, the processing system may read the token “staging environment” and set a dependency flag that references a staging server.

In block 2110, the processing system may extract routing attributes. A routing attribute guides subsequent message delivery. For example, the processing system may find a directive “management chat” and set a routing priority weight that equals 0.72.

In block 2112, the processing system may extract information-source attributes, which may include an external system that provides status data. For example, the processing system may register a Universal Resource Locator (URL) that points to a continuous-integration dashboard or a web interface that publishes build results in real time, and tag the source with a trust weight that equals 0.84.

In block 2114, the processing system may call a content-extract processor that verifies build status. For example, the processing system may issue a REST call to the dashboard, parse the returned payload, and copy the build state into the transaction context.

In block 2116, the processing system may consult a user-content discovery system (e.g., a repository that maps previous actions to outcome vectors, etc.) that stores historical action data. For example, the processing system may retrieve success metrics for the last three deployments.

In block 2118, the processing system may invoke specialized agents that evaluate compliance, relevance, access control, and aggregated analytics.

In block 2120, a regulation agent may evaluate compliance constraints on the deployment. The regulation agent may be configured to compare action attributes with regulatory rule weights. In some embodiments, the regulation agent may confirm that deployment to a staging server satisfies jurisdiction policies.

In block 2122, a relevance agent may confirm alignment with current project goals. A relevance agent may include a module that measures topical overlap between the action and project objectives. For example, the relevance agent may compute a similarity metric of 0.83 between the action vector and the project-goal vector.

In block 2124, an access-control agent may verify requester privileges. An access-control agent may include a module that maps roles to permitted actions. For example, the agent may confirm that the requester holds a role named “Release Engineer” and assign an access weight that equals 0.92.

In block 2126, an analysis agent may aggregate the outputs from the three preceding agents. An analysis agent may include a module that produces a composite decision score. For example, the analysis agent may calculate a weighted average that equals 0.88.

In block 2128, the processing system may decide whether the action remains allowed. The decision compares the composite score with an allowance threshold. Flow proceeds to block 2130 when the score meets or exceeds the threshold or to block 2132 when the score falls below the threshold.

In block 2130, the processing system may update values and weights. For example, the processing system may raise the trust weight for the requester by 0.05 because the requester initiated a compliant action.

In block 2132, the processing system may send a response that denies or delays the action when allowance fails. For example, the response may contain a status field “Denied” and a reason field “Insufficient Approval.”

In block 2134, the processing system may generate feedback that explains denial. Feedback may include a structured message that outlines required corrections. For example, the processing system may state “Add approval from Quality Assurance manager.”

In block 2136, the processing system may generate a prompt that requests missing approvals. For example, the prompt may read “Select an approver from the list and request sign-off.”

In block 2138, the processing system may generate an example that clarifies the expected approval format. For example, the system may include “Example: QA-Manager ID #57, approval-code A17” within the prompt.

In block 2140, the processing system may generate an explanation that justifies the prompt. For example, the explanation may state that the policy mandates dual approval for production deployments.

In block 2142, the processing system may evaluate sufficiency of retrieved information before repeating the orchestration cycle described above with reference to FIG. 20. For example, the processing system may verify that the new approval appears in the transaction context.

In block 2144, an information-retrieval agent may gather the requested approvals. For example, the agent may query an approval-tracking database and attach the approval record to the action vector.

In block 2146, the orchestration agent may refine routing weights to prioritize the management-chat channel because the new approval originated in that channel.

In block 2148, the orchestration agent may generate updated instructions that reflect the refined routing weights. For example, the instruction may specify “Notify Management Chat with deployment summary.” In block 2150, the storage system may store updated weights and approval records. In block 2152, the orchestration agent may complete the cycle and return a success status when the updated composite score meets the allowance threshold.

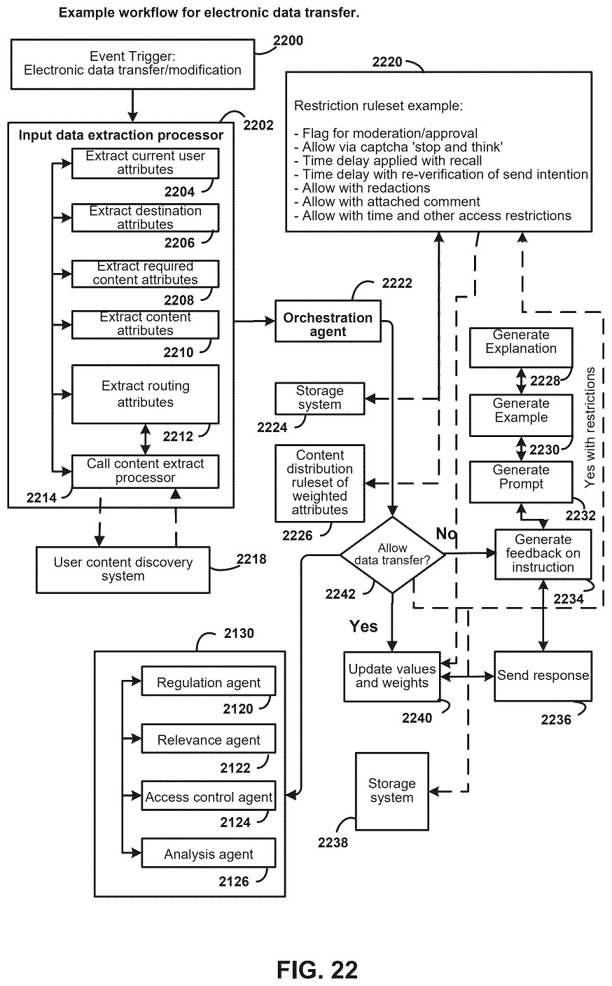

FIG. 22 is a process flow diagram that illustrates a method of governing electronic data transfer with restriction rules, orchestration, and agent validation in accordance with some embodiments. In block 2200, the processing system may detect an event trigger that references an electronic message transfer in an enterprise collaboration platform. For example, the processing system may monitor a publish-subscribe queue, read a record labeled “Send Financial Forecast,” and copy the record into volatile memory with a transaction identifier so that autonomous artificial-intelligence agents maintain context.

In block 2202, the processing system may enter an input-data extraction processor that parses the draft message into attribute vectors. For example, an autonomous linguistic-analysis agent may tokenize subject text, body text, and markup metadata, identify modal auxiliary verbs such as “may,” and store the tokens in a staging buffer. In block 2204, the processing system may extract current-user attributes such as organizational role and session context. For example, a directory-interface agent may read the sender record “Product Manager,” assign a role weight that equals 0.83, and record a session-confidence weight that equals 0.88 because multifactor authentication remains active. In block 2206, the processing system may extract destination attributes that describe target recipients. For example, an access-analysis agent may detect an external domain, assign a cross-boundary weight that equals 0.91, and mark the thread subject to export-control review.

In block 2208, the processing system may extract required content attributes such as confidentiality level. For example, a transformer-based language-model agent may classify an attached spreadsheet as “Internal-Financial,” assign a confidentiality weight that equals 0.90, and forward that weight to the orchestration context. In block 2210, the processing system may extract content attributes that describe data type. For example, the linguistic-analysis agent may read the content-type header “application/vnd.xxx.sheet,” assign a spreadsheet weight that equals 0.75, and flag embedded macros for further inspection. In block 2212, the processing system may extract routing attributes that define channel candidates. For example, a relevance agent may list secure email, encrypted file-share link, and chat link, and may assign initial routing weights of 0.80, 0.72, and 0.60 based on historical sender selections.

In block 2214, the content-extract processor may calculate a hash of the attachment and determine content length, and a user-content discovery system may retrieve destination history. For example, the processor may compute a SHA-256 hash “a4bf . . . 91e,” record a length of 524 kilobytes, and fetch five earlier transfers to the same external domain, noting that two transfers triggered compliance holds. In block 2218, a user-content discovery vector may update relevance weights after semantic comparison with historical messages. For example, a semantic-embedding agent may score an 0.87 similarity with a prior “Budget Revision” message that faced a hold, and may raise a potential-risk weight by 0.06. In block 2220, the processing system may reference a restriction-ruleset that lists moderation flags, approval delays, automatic redactions, and captcha confirmations. For example, the ruleset may state that confidentiality weight above 0.85 and cross-boundary weight above 0.90 trigger redaction of employee identifiers and a thirty-minute delayed send.

In block 2222, an orchestration agent may evaluate whether any rule applies by combining attribute weights with dynamic policy weights. For example, the orchestration agent may compute a composite restriction score that equals 0.92, exceed a threshold of 0.80, and select a restriction package named “Delay and Redact.” In block 2224, the storage system may append the composite score and the selected restriction package to a compliance-audit table so that monitoring agents track enforcement trends. In block 2226, a content-distribution ruleset may map weighted attributes to enforcement actions. For example, the ruleset may translate “Delay and Redact” into “strip personal identifiers, insert redaction notice, hold send for 30 minutes, allow recall.”

In block 2228, the orchestration agent may generate feedback because a restriction applies. For example, a linguistic-explanation module may compose “The attachment contains confidential financial projections addressed to an external domain. Redaction and delayed send apply under policy X1,” and may insert an example that displays redacted cells and an explanation that cites the policy clause. In block 2230, the processing system may display that prompt in the user interface so the sender may preview redactions or cancel the transfer. In block 2232, the processing system may capture sender edits, run linguistic analysis again, and repeat restriction evaluation when the sender selects “Resubmit” so that dynamic weights remain current. In block 2236, the processing system may decide whether communication may proceed after restrictions. For example, when the redacted attachment meets compliance thresholds, the orchestration agent may mark the message eligible for delayed send. In block 2238, the storage system may write updated weights such as an increased trust weight for the sender because the sender accepted redaction. In block 2240, the processing system may update content-risk weights and routing weights. For example, the processor may raise the weight for the encrypted file-share link after size growth moves the spreadsheet beyond inline limits.

In block 2242, the processing system may evaluate transfer permission again with updated weights. Communication may proceed when the composite permission score meets an allowance threshold. Otherwise, the feedback-generation loop may repeat. In block 2244, the processing system may pass an allowed message to a distribution agent that schedules the delayed send and records a message identifier so a recall agent may act during the delay window. In block 2246, a report agent may log the transfer event, including final weights, applied redactions, and delay expiration, in a compliance dashboard that autonomous auditing agents monitor. In block 2248, a send-response block may return status to the sender. For example, the interface may state “Message scheduled for delayed send at 14:32 UTC after redaction; recall remains available for 30 minutes.”

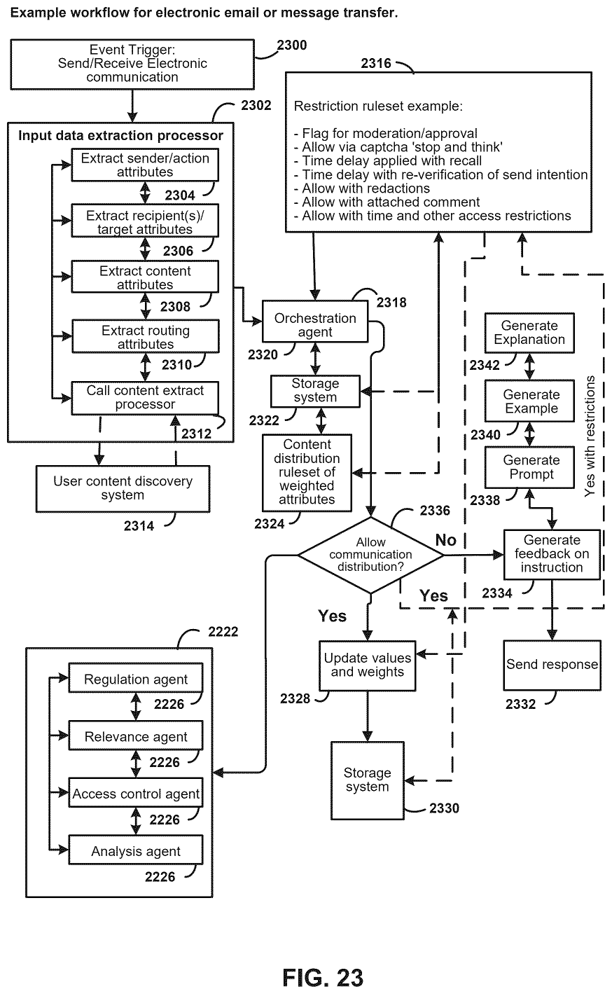

FIG. 23 is a process flow diagram that illustrates a method of controlling electronic email or message transfer with restriction rules, orchestration, and agent validation in accordance with some embodiments.

In block 2300, the processing system may detect an event trigger that references sending or receiving electronic communication. In block 2302, the processing system may start an input data extraction processor. In block 2304, the processing system may extract sender or action attributes such as identity and authentication level. In block 2306, the processing system may extract recipient attributes. In block 2308, the processing system may extract content attributes. In block 2310, the processing system may extract routing attributes. In block 2312, the processing system may call a content extract processor that tokenizes the message body. In block 2314, a user content discovery system may supply recipient history and earlier exchanges. In block 2316, the processing system may reference a restriction ruleset block. In block 2318, an orchestration agent may apply the restriction ruleset. In block 2320, a storage system may provide historical communication weights. In block 2322, a content distribution ruleset may map weighted attributes to restriction outcomes. In block 2324, the orchestration agent may refine routing or restriction decisions. In block 2326, an allow communication distribution decision may test compliance with policy. In block 2328, the processing system may update values and weights when distribution proceeds. In block 2330, the processing system may write updated weights and audit records to a storage system. In block 2332, the processing system may send a response that indicates success or restriction. In block 2334, the processing system may generate feedback when communication fails policy checks. In block 2336, the processing system may assemble a prompt that requests corrective action. In block 2338, the processing system may embed a prompt with context. In block 2340, the processing system may generate an example. In block 2342, the processing system may generate an explanation.

The various embodiments may include various specialized agents and components, which may include various operations and interactions between different agents, data storage systems, regulatory information analysis processes, and other important elements. By dynamically adjusting weights based on real-time data and feedback, the system may provide accurate and current evaluation criteria, as well as robust, adaptable solutions for managing information compliance and relevance in complex data transfer and communication environments.

The systems and methods of the various embodiments described herein may provide significant technical advancements above and beyond the current state of the art. They may implement and use advanced AI/ML techniques to automate the evaluation and management of data compliance and relevance to significantly reduce the manual effort required and increase the accuracy and reliability of these processes. By incorporating semantic and linguistic analysis, the systems can more precisely interpret and apply regulatory requirements. In addition, the dynamic adjustment of weights and continuous feedback integration may allow the system to dynamically adapt to evolving data and regulatory landscapes, especially in cross-jurisdiction and multi-lingual environments.

The systems and methods of the various embodiments described herein may use techniques that provide significant technical efficiencies above and beyond the current state of the art. For example, the use of semantic embeddings and language models allows for more efficient data processing and analysis, reducing the computational resources required. The orchestration of interactions between autonomous AI agents may greatly improve the evaluation process and allow for real-time assessments and decision-making. In addition, the implementation of dynamic weight adjustments based on real-time feedback may reduce the need for extensive manual interventions and reconfigurations.

The various embodiments presented in this application include technological solutions that distinctly enhance the functionality and performance of computing devices. For example, by integrating advanced AI agents into the data processing workflow, computing devices may handle larger volumes of data with greater precision and speed. The ability to perform detailed semantic and linguistic analysis on regulatory documents allows these devices to more effectively verify compliance. In addition, the use of machine learning techniques to continuously refine evaluation criteria may improve the system's performance by, for example, making it more adaptable to new types of data and evolving regulatory standards.

The disclosed embodiments also offer technical solutions to various tangible technical problems. For example, they address the challenge of unauthorized data dissemination by implementing robust AI-driven compliance checks that evaluate data against regulatory requirements before allowing its transfer or distribution. They also solve the problem of data relevance by using weighted metrics to prioritize information so that recipients receive the most pertinent and timely data. In addition, by continuously integrating feedback and newly identified information external to the organization and updating stored values and weights, the embodiments provide a technical solution to considerable technical problems associated with maintaining up-to-date compliance and relevance standards.

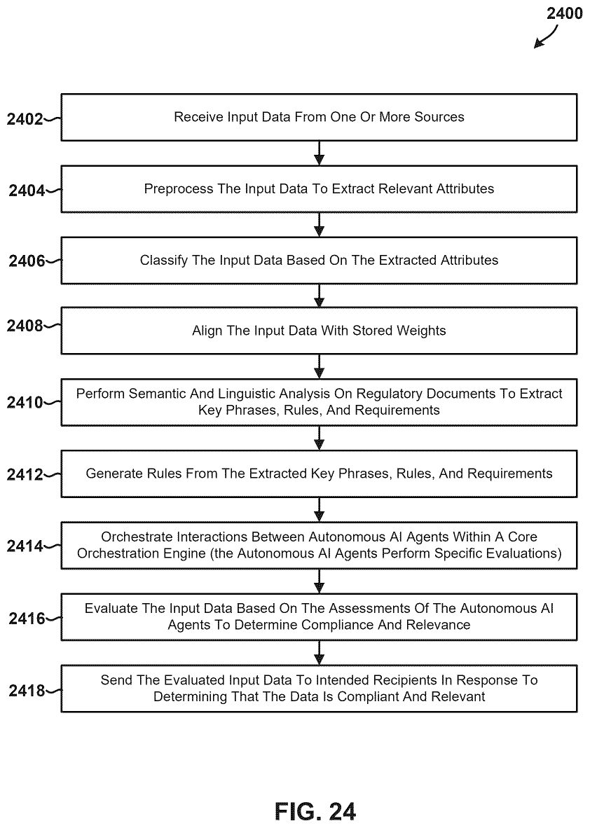

FIG. 24 illustrates a method 2400 of using artificial intelligence (AI) agents to manage and evaluate the compliance and relevance of information and actions within a communication and data transfer environment in accordance with some embodiments.

In block 2402, the processing system may receive input data from one or more sources. For example, the processing system may poll remote APIs, ingest electronic documents from databases, or retrieve real-time chat messages transmitted by a messaging service. These operations may allow the system acquire necessary data from diverse, distributed sources, providing content for subsequent compliance and relevance evaluations performed by downstream AI agents.

In block 2404, the processing system may preprocess the input data to extract relevant attributes. For example, the processing system may tokenize textual content, normalize formatting, remove extraneous symbols, or identify metadata tags and semantic entities within the content. These preprocessing operations may standardize heterogeneous data into structured attribute formats to allow for more accurate classification and alignment tasks.

In block 2406, the processing system may classify the input data based on the extracted attributes. For example, the processing system may use a trained classification model to categorize data according to confidentiality levels, content types, or regulatory relevance using the extracted structured attributes. These classification operations may allow for more accurate differentiation among diverse data sets and/or the precise evaluation of compliance, security, and relevance by specialized downstream AI agents.

In block 2408, the processing system may align the input data with stored weights. For example, the processing system may represent extracted attributes and textual content as semantic embeddings and compare these embeddings against stored weight matrices corresponding to regulatory priorities or user-defined preferences. These alignment operations may quantitatively assesses the relative importance or compliance sensitivity of the input data to allow for dynamic adjustments to evaluation thresholds or content prioritization.

In some embodiments, classifying the input data based on the extracted attributes in block 2406 and/or aligning the input data with the stored weights in block 2408 may include using semantic embeddings and language models to extract key phrases and rules from the input texts.

In block 2410, the processing system may perform semantic and linguistic analysis on regulatory documents to extract key phrases, rules, and requirements. For example, the processing system may parse regulatory texts to identify modal auxiliary verbs such as “may,” “shall,” or “should,” distinguishing between mandatory and permissive obligations, and utilize advanced language models to recognize complex linguistic patterns. The semantic and linguistic analysis may allow for a more precise extraction of regulatory intent and obligations and/or allow for generating more accurate and actionable rules for compliance enforcement.

In some embodiments, performing the semantic and linguistic analysis on the regulatory documents to extract the key phrases, rules, and requirements may include performing part of speech analysis on regulatory documents to identify modal auxiliary verbs and distinguish between mandatory and optional actions. In some embodiments, performing the semantic and linguistic analysis on the regulatory documents to extract the key phrases, rules, and requirements may include performing part of speech analysis on regulatory documents to identify modal auxiliary verbs and other linguistic features, extracting key phrases, rules, and requirements using advanced language models, and generating rules from the extracted key phrases, rules, and requirements.

In block 2412, the processing system may generate rules from the extracted key phrases, rules, and requirements. For example, the processing system may transform identified mandatory obligations from regulatory texts into structured, executable logic statements or policies that autonomous AI agents may subsequently use during compliance evaluations. The generation of these structured rules may help ensure clarity, consistency, and automated applicability of regulatory compliance criteria within the data transfer and communication environment.

In block 2414, the processing system may orchestrate interactions between autonomous AI agents within a core orchestration engine so that the autonomous AI agents perform specific evaluations. For example, the processing system may coordinate real-time exchanges of structured rule sets, dynamically adjust evaluation weights based on data streams, or schedule sequential evaluation tasks among compliance agents, relevance agents, security agents, and analysis agents. These orchestration operations may allow for more coherent and collaborative agent activities and/or for more comprehensive, accurate, and efficient compliance, security, and relevance evaluations of the input data.

In some embodiments, orchestrating interactions between the autonomous AI agents may include dynamically adjusting the weights assigned to one or more of the attributes based on real-time data and feedback. In some embodiments, orchestrating interactions between the autonomous AI agents may include facilitating communication and collaboration between the compliance agent, relevance agent, security agent, and analysis agent. In some embodiments, orchestrating interactions between the autonomous AI agents may include managing interactions between the compliance agent, relevance agent, security agent, and analysis agent using the core orchestration engine, and evaluating the input data based on the assessments of the compliance agent, relevance agent, security agent, and analysis agent.

In block 2416, the processing system may evaluate the input data based on the assessments of the autonomous AI agents to determine compliance and relevance. For example, the processing system may aggregate numeric assessment scores from the compliance agent, relevance agent, security agent, and analysis agent, compare these aggregated scores against predefined thresholds, and determine whether the input data satisfies required compliance and relevance criteria. These evaluation operations may provide a robust, quantitative basis for approving or rejecting the distribution of information and/or may help ensure that only compliant and contextually relevant data reaches intended recipients.

In block 2418, the processing system may send the evaluated input data to intended recipients in response to determining that the data is compliant and relevant. For example, the processing system may prioritize outgoing messages based on calculated urgency weights or recipient-specific relevance scores, transmit compliant data through secure communication channels, collect explicit user feedback, and subsequently update stored regulatory or preference weights according to recipient responses. Such delivery and feedback mechanism may help ensure ongoing refinement of the evaluation system, continuously improving the precision and responsiveness of compliance and relevance assessments conducted by autonomous AI agents.

In some embodiments, sending the evaluated input data to the intended recipients in response to determining that the data is compliant and relevant may include implementing weighted metrics to prioritize the relevance and urgency of the information. In some embodiments, sending the evaluated input data to the intended recipients in response to determining that the data is compliant and relevant may include sending the compliant and relevant data to the intended recipients, collecting feedback from the recipients regarding the relevance and compliance of the data, and updating stored values and weights based on the collected feedback.

In some embodiments, the processing system may be further configured to generate feedback based on the evaluation and distribution of the data, update stored values and weights based on the generated feedback, store processed data, analysis results, and distribution records in a storage system, and periodically update the storage system based on new data and feedback. In some embodiments, the operations for storing the processed data, analysis results, and/or distribution records may further include maintaining indexes, original data inputs, and connections between indexed data and the original inputs, and organizing stored data into regulation storage, user content storage, and user access storage.

In some embodiments, the processing system may be further configured to update stored values and weights by monitoring system performance and feedback, updating the semantic store, regulation weights, content weights, and access control weights, and adjusting agent interactions and evaluation criteria based on updated data.

In some embodiments, the processing system may be further configured to generate a report based on the evaluated input data by triggering a report generation event based on predefined schedules or feedback, gathering and classifying necessary information for the report, generating the report structure based on stored requirements and feedback, determining whether the gathered information is sufficient, generating and distributing the report in response to determining the gathered information is sufficient, and generating feedback and updating values and weights in response to determining the gathered information is insufficient. In some embodiments, the processing system may be further configured to use AI or machine learning techniques to refine the evaluation criteria for updating stored values and weights.

In some embodiments, the processing system may be configured to evaluate the data relevance using weighted metrics. In some embodiments, the processing system may be configured to evaluate the data relevance by using calculated weights related to content to determine the relevance of the data to the intended recipients and applying the weights dynamically based on real-time analysis and feedback. In some embodiments, the processing system may be configured to evaluate the data relevance by using calculated weights related to content to determine the relevance of the data to the intended recipients, and using calculated weights related to actions to evaluate the relevance and regulatory compliance of proposed actions.

In some embodiments, the processing system may be configured to detect a user's preferred communication language and preferred information presentation format. For example, the processing system may analyze user profile settings, historical communication patterns, or browser settings to determine the user's preferred language and data format. In response to detecting differences between the user's preferred language and the language of stored communications, the processing system may automatically translate stored information into the user's preferred language. The processing system may utilize an autonomous language-translation agent that converts stored text from a source language (e.g., Spanish, etc.) to a target language (e.g., English, etc.) before presenting the translated text to the user. In some embodiments, the processing system may persist the translated communication in memory or storage after an initial translation, which may improve computational efficiency by eliminating the requirement to retranslate identical content upon subsequent user requests. For example, after translating Spanish communications to English for one user, the system may reuse the previously translated content when another user later requests the same communication content in English, provided no substantial change has occurred in the underlying communication content.

In some embodiments, the processing system may be configured to enhance or optimize storage and computational efficiency by evaluating and storing translated communications or communication summaries based on detected changes to the underlying source content. In some embodiments, the processing system may accomplish this by using semantic embeddings, numeric representation tokens, or vector-space mappings stored in hyperdimensional memory spaces. For example, the processing system may represent each communication using embeddings generated by language models, calculate distances between embeddings of original and modified communications, and determine whether these distances exceed predefined threshold values. In response to determining that changes in communication content fall below threshold values, the processing system may reuse previously translated or summarized content. These operations may reduce redundant processing, storage requirements, and computational overhead.

Some embodiments may reduce computational load and storage overhead by reducing to minimizing redundant translation and summarization computations. These enhancements and efficiencies may result from leveraging embedding-based evaluations to determine necessary re-computations, which may improve overall system performance, scalability, and responsiveness for users communicating in diverse languages and information formats.

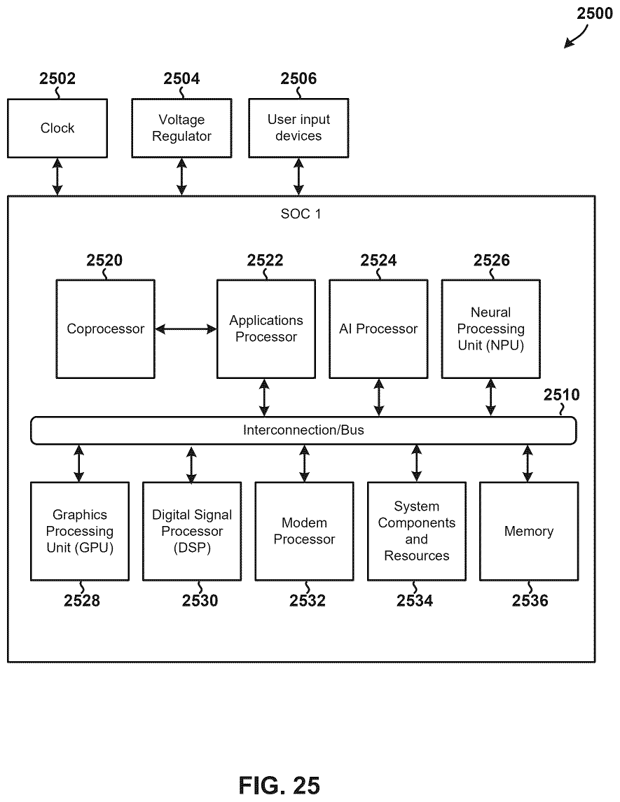

Various embodiments may be implemented on a number of single-processor and multiprocessor computer systems, including a system-on-chip (SOC) or system in a package (SIP). FIG. 25 illustrates an example computing system or SOC 2500 architecture that may be used in user end devices implementing the various embodiments.

With reference to FIG. 25, the illustrated example SOC 2500 includes a clock 2506, a voltage regulator 2508, and user input devices 2570 (e.g., a touch-sensitive display, a touch pad, a mouse, etc.). The SOC 2500 may communicate via interconnection bus 2530, which may include advanced interconnects such as high-performance networks-on-chip (NOCs) and/or an array of reconfigurable logic gates and/or implement a bus architecture (e.g., CoreConnect, AMBA, etc.). Various processors 2510, 2512, 2514, 2516, 2518, 2522, 2524, may be interconnected to each other and to one or more memory elements 2520, system components and resources 2526, etc. In various embodiments, any, or all of the processors 2510, 2512, 2514, 2516, 2518, 2522, 2524, in the system may operate as the SoC's main processor, central processing unit (CPU), microprocessor unit (MPU), arithmetic logic unit (ALU), etc. One or more of the coprocessors 2518 may operate as the CPU. In some embodiments, the SOC 2500 may operate as the CPU of the computing device that carries out the instructions of software application programs by performing the arithmetic, logical, control and input/output (I/O) operations specified by the instructions.

The SOC 2500 may include a digital signal processor (DSP) 2510, a modem processor 2512, a graphics processor 2514, an application processor 2516, one or more coprocessors 2518 (e.g., vector co-processor, CPUCP, etc.) connected to one or more of the processors, memory 2520, deep processing unit (DPU) 2522 for convolutional neural networks, artificial intelligence processor 2524, system components and resources 2526, an interconnection bus 2530, and various additional processors, such as an applications processor, packet processor, etc.

Each processor 2510, 2512, 2514, 2516, 2518, 2522, 2524 may include one or more cores, and each processor/core may perform operations independent of the other processors/cores. For example, the first SOC 102 may include a processor that executes a first type of operating system (e.g., FreeBSD, LINUX, OS X, etc.) and a processor that executes a second type of operating system (e.g., MICROSOFT WINDOWS 11). In addition, any, or all of the processors 2510, 2512, 2514, 2516, 2518, 2522, 2524 may be included as part of a processor cluster architecture (e.g., a synchronous processor cluster architecture, an asynchronous or heterogeneous processor cluster architecture, etc.).

Any or all of the processors 2510, 2512, 2514, 2516, 2518, 2522, 2524 may operate as the CPU of the mobile computing device. In addition, any, or all of the processors 2510, 2512, 2514, 2516, 2518, 2522, 2524 may be included as one or more nodes in one or more CPU clusters. A CPU cluster may be a group of interconnected nodes (e.g., processing cores, processors, SOCs, SIPs, computing devices, etc.) configured to work in a coordinated manner to perform a computing task. Each node may run its own operating system and contain its own CPU, memory, and storage. A task that is assigned to the CPU cluster may be divided into smaller tasks that are distributed across the individual nodes for processing. The nodes may work together to complete the task, with each node handling a portion of the computation. The results of each node's computation may be combined to produce a final result. CPU clusters are especially useful for tasks that can be parallelized and executed simultaneously. This allows CPU clusters to complete tasks much faster than a single, high-performance computer. Additionally, because CPU clusters are made up of multiple nodes, they are often more reliable and less prone to failure than a single high-performance component.

The SOC 2500 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources of the SOC 2500 may include power amplifiers, voltage regulators, oscillators, phase-locked loops, peripheral bridges, data controllers, memory controllers, system controllers, Access ports, timers, and other similar components used to support the processors and software clients running on a computing device. The system components and resources may also include circuitry to interface with peripheral devices, such as cameras, electronic displays, wireless communication devices, external memory chips, etc.

The SOC 2500 may further include an input/output module (not illustrated) for communicating with resources external to the SOC, such as the clock, the voltage regulator, user input devices (e.g., a touch-sensitive display, a touch pad, a mouse, etc.), wireless transceiver (e.g., cellular wireless transceiver, Bluetooth transceiver, etc.), a user facing camera, etc. Resources external to the SOC (e.g., clock 2506, voltage regulator 2508, etc.) may be shared by two or more of the internal SOC processors/cores.

In addition to the example SOC 2500 discussed above, various embodiments may be implemented in various computing systems, including a single processor, multiple processors, multicore processors, or any combination thereof.

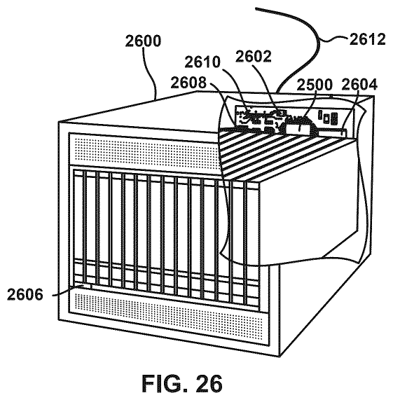

Some embodiments may be implemented on a variety of commercially available computing devices, such as the server computing device 2600 illustrated in FIG. 26. The server device 2600 may include one or more processors 2601 (e.g., multi-core processor, etc.) coupled to volatile memory 2602, such as RAM, and a large capacity nonvolatile memory, such as a solid-state drive (SSD) 2603. The server device 2600 may also include additional storage interfaces such as USB ports and NVMe slots coupled to the processor 2601. The server device 2600 may include network access ports 2606 coupled to the processor 2601 that allow data connections through a network interface card (NIC) 2604 and a communication network 2607 (e.g., an Internet Protocol (IP) network) connected to other network elements.

The processors discussed in this application (e.g., 2510, 2512, 2514, 2516, 2518, 2522, 2524, 2601, etc.) may be any programmable microprocessor, microcomputer, or a combination of multiple processor chips configured by software instructions (applications) to perform diverse functions, including those of the various embodiments described herein. Severs 2600 often include multiple processors, with dedicated processors for specific tasks such as managing cloud computing operations, data analytics, or wireless communication functions. Software applications may be stored in the internal memory (2602, 2603) before being accessed and executed by the processor 2601. Modern processors 2601 may include extensive internal memory, often augmented with fast access cache memory, to efficiently store and process application software instructions.

Implementation examples are described in the following paragraphs. While some of the following implementation examples are described in terms of example methods, further example implementations may include: the example methods discussed in the following paragraphs implemented by a computing system including a processor configured (e.g., with processor-executable instructions) to perform operations of the methods of the following implementation examples; the example methods discussed in the following paragraphs implemented by a computing system including means for performing functions of the methods of the following implementation examples; and the example methods discussed in the following paragraphs may be implemented as a non-transitory processor-readable storage medium having stored thereon processor-executable instructions configured to cause a processor of a computing system to perform the operations of the methods of the following implementation examples.

Example 1: A method for using artificial intelligence (AI) agents to manage and evaluate the compliance and relevance of information and actions within a communication and data transfer environment, the method including receiving input data from one or more sources, preprocessing the input data to extract relevant attributes, classifying the input data based on the extracted attributes, aligning the input data with stored weights, performing semantic and linguistic analysis on regulatory documents to extract key phrases, rules, and requirements, generating rules from the extracted key phrases, rules, and requirements, orchestrating interactions between autonomous AI agents within a core orchestration engine, in which the autonomous AI agents perform specific evaluations, evaluating the input data based on the assessments of the autonomous AI agents to determine compliance and relevance, and sending the evaluated input data to intended recipients in response to determining that the data is compliant and relevant.

Example 2: The method of example 1, further including generating feedback based on the evaluation and distribution of the data, updating stored values and weights based on the generated feedback, storing processed data, analysis results, and distribution records in a storage system, and periodically updating the storage system based on new data and feedback.

Example 3: The method of any of the examples 1 and 2, in which storing the processed data, analysis results, and distribution records further includes maintaining indexes, original data inputs, and connections between indexed data and the original inputs, and organizing stored data into regulation storage, user content storage, and user access storage.

Example 4: The method of any of the examples 1-3, in which classifying the input data based on the extracted attributes and aligning the input data with the stored weights further includes using semantic embeddings and language models to extract key phrases and rules from the input texts.

Example 5: The method of any of the examples 1-4, in which performing the semantic and linguistic analysis on the regulatory documents to extract the key phrases, rules, and requirements further includes performing part of speech analysis on regulatory documents to identify model/auxiliary verbs and distinguish between mandatory and optional actions.

Example 6: The method of any of the examples 1-5, in which performing the semantic and linguistic analysis on the regulatory documents to extract the key phrases, rules, and requirements further includes performing part of speech analysis on regulatory documents to identify model/auxiliary verbs and other linguistic features, extracting key phrases, rules, and requirements using advanced language models, and generating rules from the extracted key phrases, rules, and requirements.

Example 7: The method of any of the examples 1-6, in which orchestrating interactions between the autonomous AI agents further includes dynamically adjusting the weights assigned to one or more of the attributes based on real-time data and feedback.

Example 8: The method of any of the examples 1-7, in which orchestrating interactions between autonomous AI agents further includes facilitating communication and collaboration between the compliance agent, relevance agent, security agent, and analysis agent.

Example 9: The method of any of the examples 1-8, in which orchestrating interactions between autonomous AI agents further includes managing interactions between the compliance agent, relevance agent, security agent, and analysis agent using the core orchestration engine, and evaluating the input data based on the assessments of the compliance agent, relevance agent, security agent, and analysis agent.

Example 10: The method of any of the examples 1-9, in which sending the evaluated input data to the intended recipients in response to determining that the data is compliant and relevant further includes implementing weighted metrics to prioritize the relevance and urgency of the information.

Example 11: The method of any of the examples 1-10, in which sending the evaluated input data to the intended recipients in response to determining that the data is compliant and relevant further includes sending the compliant and relevant data to the intended recipients, collecting feedback from the recipients regarding the relevance and compliance of the data, and updating stored values and weights based on the collected feedback.

Example 12: The method of any of the examples 1-11, further including updating stored values and weights by monitoring system performance and feedback, updating the semantic store, regulation weights, content weights, and access control weights, and adjusting agent interactions and evaluation criteria based on updated data.

Example 13: The method of any of the examples 1-12, further including generating a report based on the evaluated input data by triggering a report generation event based on predefined schedules or feedback, gathering and classifying necessary information for the report, generating the report structure based on stored requirements and feedback, determining whether the gathered information is sufficient, generating and distributing the report in response to determining the gathered information is sufficient, and generating feedback and updating values and weights in response to determining the gathered information is insufficient.

Example 14: The method of any of the examples 1-13, further including using AI or machine learning techniques to refine the evaluation criteria for updating stored values and weights.

Example 15: The method of any of the examples 1-14, further including evaluating the data relevance using weighted metrics, in which evaluating the data relevance includes using calculated weights related to content to determine the relevance of the data to the intended recipients, and applying the weights dynamically based on real-time analysis and feedback.

Example 16: The method of any of the examples 1-15, further including evaluating the data relevance using weighted metrics, in which evaluating the data relevance includes using calculated weights related to content to determine the relevance of the data to the intended recipients, and using calculated weights related to actions to evaluate the relevance and regulatory compliance of proposed actions.

Example 17: The method of any of the examples 1-16, further including detecting a preferred communication language or information format associated with an intended recipient, determining whether stored communication content corresponds to the detected preferred communication language or information format, and in response to determining that the stored communication content does not correspond to the detected preferred communication language or information format, translating, by an autonomous translation agent executed by the processing system, the stored communication content into the detected preferred communication language or converting the content into the detected information format, generating semantic embeddings or numeric representation tokens representing the translated or converted communication content, calculating embedding distances between previously stored embeddings of the communication content and embeddings of current communication content versions, and persisting translated or converted communication content for subsequent reuse in response to determining that calculated embedding distances do not exceed a predefined threshold.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A number of different types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in a computing device, system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processing system may be a microprocessor, but, in the alternative, the processing system may be any conventional processor, controller, microcontroller, or state machine. A processing system may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, solid-state drives (SSD), non-volatile memory express (NVMe) drives, three-dimensional (3D) NAND flash, or any other medium that may be used to store target program code in the form of instructions or data structures and that may be accessed by a computer. Modern technologies, such as cloud-based storage solutions, including infrastructure-as-a-service (IaaS) platforms, may offer scalable and distributed options for storing and accessing program code. Additionally, the operations of a method or algorithm may reside as one or any combination or set of codes and/or instructions on a non-transitory processor-readable medium and/or computer-readable medium, which may be incorporated into a computer program product. Emerging technologies, including quantum computing storage media and blockchain-based storage solutions, may further enhance data integrity and security. Artificial intelligence (AI) and machine learning (ML)-optimized hardware accelerators, such as graphical processing units (GPUs) and tensor processing units (TPUs), may be used to execute complex algorithms.

The preceding description of the disclosed aspects is provided to enable any person skilled in the art to make or use the present invention. Various modifications to these aspects may be readily apparent to those skilled in the art, and the generic principles defined herein may be applied to other aspects without departing from the scope of the invention. Thus, the present invention is not intended to be limited to the aspects shown herein but is to be accorded the widest scope consistent with the following claims and the principles and novel features disclosed herein.

What is claimed is:

1. A computing device, comprising:
a processing system comprising one or more processors configured to use artificial intelligence (AI) agents to manage and evaluate the compliance and relevance of information and actions within a communication and data transfer environment by:
receiving input data from one or more sources;
preprocessing the input data to extract relevant attributes;
classifying the input data based on the extracted attributes;
aligning the input data with stored weights;
performing semantic and linguistic analysis on regulatory documents to extract key phrases, rules, and requirements;
generating rules from the extracted key phrases, rules, and requirements;
orchestrating interactions between autonomous AI agents within a core orchestration engine, wherein the autonomous AI agents perform specific evaluations;
evaluating the input data based on the assessments of the autonomous AI agents to determine compliance and relevance; and
sending the evaluated input data to intended recipients in response to determining that the data is compliant and relevant.

2. The computing device of claim 1, wherein the one or more processors are further configured to:
generate feedback based on the evaluation and distribution of the data;
update stored values and weights based on the generated feedback;
store processed data, analysis results, and distribution records in a storage system; and
periodically update the storage system based on new data and feedback.

3. The computing device of claim 2, wherein the one or more processors are configured so that storing the processed data, analysis results, and distribution records further comprises:
maintaining indexes, original data inputs, and connections between indexed data and the original inputs; and
organizing stored data into regulation storage, user content storage, and user access storage.

4. The computing device of claim 1, wherein the one or more processors are configured so that classifying the input data based on the extracted attributes and aligning the input data with the stored weights further comprises:
using semantic embeddings and language models to extract key phrases and rules from the input texts.

5. The computing device of claim 1, wherein the one or more processors are configured so that performing the semantic and linguistic analysis on the regulatory documents to extract the key phrases, rules, and requirements further comprises:
performing part of speech analysis on regulatory documents to identify modal auxiliary verbs and distinguish between mandatory and optional actions.

6. The computing device of claim 1, wherein the one or more processors are configured so that performing the semantic and linguistic analysis on the regulatory documents to extract the key phrases, rules, and requirements further comprises:
performing part of speech analysis on regulatory documents to identify modal auxiliary verbs and other linguistic features;
extracting key phrases, rules, and requirements using advanced language models; and
generating rules from the extracted key phrases, rules, and requirements.

7. The computing device of claim 1, wherein the one or more processors are configured so that orchestrating interactions between the autonomous AI agents further comprises:
dynamically adjusting the weights assigned to one or more of the attributes based on real-time data and feedback.

8. The computing device of claim 1, wherein the one or more processors are configured so that orchestrating interactions between autonomous AI agents further comprises:
facilitating communication and collaboration between the compliance agent, relevance agent, security agent, and analysis agent.

9. The computing device of claim 1, wherein the one or more processors are configured so that orchestrating interactions between autonomous AI agents further comprises:
managing interactions between the compliance agent, relevance agent, security agent, and analysis agent using the core orchestration engine; and
evaluating the input data based on the assessments of the compliance agent, relevance agent, security agent, and analysis agent.

10. The computing device of claim 1, wherein the one or more processors are configured so that sending the evaluated input data to the intended recipients in response to determining that the data is compliant and relevant further comprises:
implementing weighted metrics to prioritize the relevance and urgency of the information.

11. The computing device of claim 1, wherein the one or more processors are configured so that sending the evaluated input data to the intended recipients in response to determining that the data is compliant and relevant further comprises:
sending the compliant and relevant data to the intended recipients;
collecting feedback from the recipients regarding the relevance and compliance of the data; and
updating stored values and weights based on the collected feedback.

12. The computing device of claim 1, wherein the one or more processors are further configured to update stored values and weights by:
monitoring system performance and feedback;
updating the semantic store, regulation weights, content weights, and access control weights; and
adjusting agent interactions and evaluation criteria based on updated data.

13. The computing device of claim 1, wherein the one or more processors are further configured to generate a report based on the evaluated input data by:
triggering a report generation event based on predefined schedules or feedback;
gathering and classifying necessary information for the report;
generating the report structure based on stored requirements and feedback;
determining whether the gathered information is sufficient;
generating and distributing the report in response to determining the gathered information is sufficient; and
generating feedback and updating values and weights in response to determining the gathered information is insufficient.

14. The computing device of claim 1, wherein the one or more processors are further configured to use AI or machine learning techniques to refine the evaluation criteria for updating stored values and weights.

15. The computing device of claim 1, wherein:
the one or more processors are further configured to evaluate the data relevance using weighted metrics; and
the one or more processors are configured to evaluate the data relevance by:
using calculated weights related to content to determine the relevance of the data to the intended recipients; and
applying the weights dynamically based on real-time analysis and feedback.

16. The computing device of claim 1, wherein:
the one or more processors are further configured to evaluate the data relevance using weighted metrics; and
the one or more processors are configured to evaluate the data relevance by:
using calculated weights related to content to determine the relevance of the data to the intended recipients; and
using calculated weights related to actions to evaluate the relevance and regulatory compliance of proposed actions.

17. The computing device of claim 1, wherein the one or more processors are further configured to:
detect a preferred communication language or information format associated with an intended recipient;
determine whether stored communication content corresponds to the detected preferred communication language or information format; and
in response to determining that the stored communication content does not correspond to the detected preferred communication language or information format:
translate, by an autonomous translation agent executed by the processing system, the stored communication content into the detected preferred communication language or convert the content into the detected information format;
generate semantic embeddings or numeric representation tokens representing the translated or converted communication content;
calculate embedding distances between previously stored embeddings of the communication content and embeddings of current communication content versions; and
persist translated or converted communication content for subsequent reuse in response to determining that calculated embedding distances do not exceed a predefined threshold.

18. A method performed by a processing system in a computing device for using artificial intelligence (AI) agents to manage and evaluate the compliance and relevance of information and actions within a communication and data transfer environment, the method comprising:
receiving input data from one or more sources;
preprocessing the input data to extract relevant attributes;
classifying the input data based on the extracted attributes;
aligning the input data with stored weights;
performing semantic and linguistic analysis on regulatory documents to extract key phrases, rules, and requirements;
generating rules from the extracted key phrases, rules, and requirements;
orchestrating interactions between autonomous AI agents within a core orchestration engine, wherein the autonomous AI agents perform specific evaluations;
evaluating the input data based on the assessments of the autonomous AI agents to determine compliance and relevance; and
sending the evaluated input data to intended recipients in response to determining that the data is compliant and relevant.

19. The method of claim 18, further comprising:
detecting a preferred communication language or information format associated with an intended recipient;
determining whether stored communication content corresponds to the detected preferred communication language or information format; and
in response to determining that the stored communication content does not correspond to the detected preferred communication language or information format:
translating, by an autonomous translation agent executed by the processing system, the stored communication content into the detected preferred communication language or converting the content into the detected information format;
generating semantic embeddings or numeric representation tokens representing the translated or converted communication content;
calculating embedding distances between previously stored embeddings of the communication content and embeddings of current communication content versions; and
persisting translated or converted communication content for subsequent reuse in response to determining that calculated embedding distances do not exceed a predefined threshold.

20. A non-transitory processor readable media having stored thereon processor-executable instructions configured to cause a processing system in a computing device to perform operations for using artificial intelligence (AI) agents to manage and evaluate the compliance and relevance of information and actions within a communication and data transfer environment, the operations comprising:
receiving input data from one or more sources;
preprocessing the input data to extract relevant attributes;
classifying the input data based on the extracted attributes;
aligning the input data with stored weights;
performing semantic and linguistic analysis on regulatory documents to extract key phrases, rules, and requirements;
generating rules from the extracted key phrases, rules, and requirements;
orchestrating interactions between autonomous AI agents within a core orchestration engine, wherein the autonomous AI agents perform specific evaluations;
evaluating the input data based on the assessments of the autonomous AI agents to determine compliance and relevance; and
sending the evaluated input data to intended recipients in response to determining that the data is compliant and relevant.
